(19) United States
(12) Patent Application Publication
(10) Pub. No.: US 2023/0227314 A1
(43) Pub. Date: Jul. 20, 2023

(54) CARBON NANOSTRUCTURE COMPOSITIONS AND METHODS FOR PURIFICATION THEREOF

(71) Applicants: Nano-C, Inc., Westwood, MA (US); The Board of Trustees of the Leland Stanford Junior University, Stanford, CA (US)

(72) Inventors: Zhenan BAO, Stanford, CA (US); Theodore Z. GAO, Stanford, CA (US); Xiang XUE, Winchester, MA (US); Edward A. JACKSON, Franklin, MA (US); Colleen E. TREACY, Somerville, MA (US); Ramesh SIVARAJAN, Shrewsbury, MA (US)

(21) Appl. No.: 17/998,425

(22) PCT Filed: May 11, 2021
(86) PCT No.: PCT/US21/31693

§ 371 Date: Nov. 10, 2022

Related U.S. Application Data
(60) Provisional application No. 63/024,790, filed on May 14, 2020.

(51) Int. Cl. C01B 32/172

(52) U.S. Cl. CPC C01B 32/172; C01B 2202/02; B82Y 40/00

(57) ABSTRACT

The present invention relates to carbon nanostructure compositions such as single walled carbon nanotubes (SWCNT), and methods for purification thereof, such as separation by their electronic types (e.g., primarily semiconductor enrichment). The type separated, semiconducting SWCNTs, can be used in many downstream applications such as printed electronics, sensors, optoelectronics and solar energy conversion, among other applications.

### CROSS-REFERENCE TO RELATED APPLICATIONS

This patent application is a National Stage Entry of PCT International Application Number PCT/US21/31693, filed on May 11, 2021, which claims the benefit of the earlier filing date of U.S. Patent Application No. 63/024,790, filed on May 14, 2020, the contents of which are incorporated by reference herein in their entireties.

This patent disclosure may contain material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### INCORPORATION BY REFERENCE

Any patent, patent publication, journal publication, or other document cited herein is expressly incorporated herein by reference in its entirety.

### FIELD OF THE INVENTION

The present invention relates to carbon nanostructure compositions such as single walled carbon nanotubes (SWCNT), and methods for purification thereof, such as separation by their electronic types (e.g., primarily semiconductor enrichment).

### BACKGROUND OF THE INVENTION

Single-walled carbon nanotubes (SWCNTs) are promising candidates as an advanced electronic material for applications in the emerging area of flexible and stretchable electronics. However, typical production methods tend to form a natural, statistical distribution of electronic types with a third being metallic and the other two thirds showing semiconducting behavior. While many applications can be addressed with a mixture of electronic types, electronic device applications like Thin Film Transistors (TFTs), Logic Circuitry and Sensors require SWCNTs of single electronic type at very high purities.

### SUMMARY OF THE INVENTION

In one aspect, methods for separating single-walled carbon nanotubes (SWNTs) from a mixture comprising SWNTs of a plurality of electronic types, chiralities or subset thereof are provided comprising,

a) providing a separation mixture comprising a supramolecular polymer and/or chemical additive, and a solvent,

wherein the supramolecular polymer is configured to selectively disperse SWNTs of one electronic quality, chiral portion, or subset thereof from the SWNT mixture, and

wherein the chemical additive increases at least one of:
i) selectivity of the supramolecular polymer, or
ii) ability of the supramolecular polymer to enhance the separation yield of SWNTs of the one electronic quality, chiral portion, or subset thereof; and

b) isolating a composition enriched in SWNTs of an electronic quality, chiral portion, or subset thereof.

In some embodiments, the supramolecular polymer comprises a disassembled supramolecular polymer, and the providing step further comprises providing a bond disrupting agent and adding an antisolvent to the solution.

In some embodiments, the methods further comprise precipitating the supramolecular polymer and isolating the precipitated supramolecular polymer.

In some embodiments, the separation mixture comprises a dispersed complex comprising the supramolecular polymer and SWNTs of one electronic quality, chiral portion, or subset thereof.

In some embodiments, the methods further comprise providing a bond disrupting agent to the dispersed complex.

In some embodiments, the supramolecular polymer is disassembled and SWNTs of one electronic quality, chiral portion, or subset thereof are released.

In some embodiments, the chemical additive comprises a structural unit selected from the group consisting of:

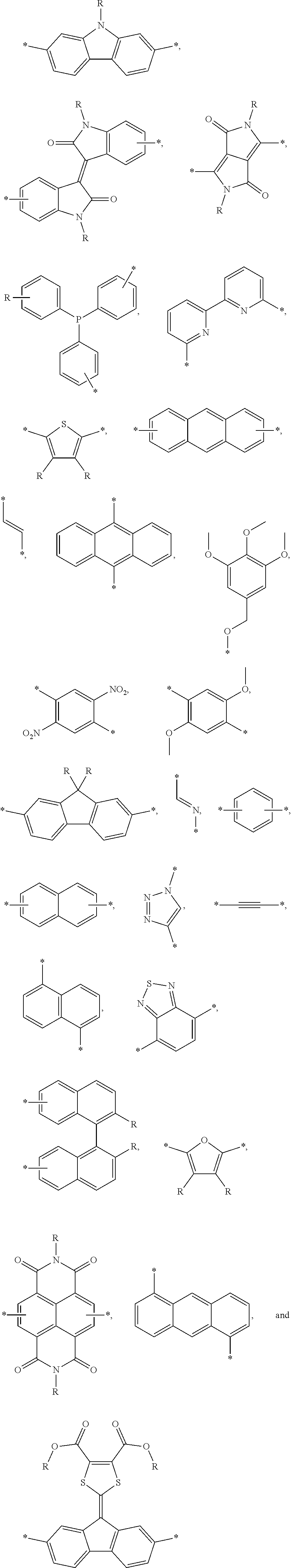

wherein
each R group is independently selected from the group consisting of H, F, Br, Cl, —CN, —NC, —NCO, —NCS, —OCN, —SCN, —C(O)NR⁰R⁰⁰, —C(O)X⁰, —C(O)R⁰, —C(O)OR⁰, —NH₂, —NR⁰R⁰⁰, —SH, —SR⁰, —SO₃H, —SO₂R⁰, —OH, —NO₂, —CF₃, —SF₅, or optionally substituted silyl, carbyl or hydrocarbyl with 1 to 40 C atoms that is optionally substituted and optionally comprises one or more hetero atoms;
each R⁰ and R⁰⁰ are independently H or optionally substituted C₁₋₄₀ carbyl or hydrocarbyl; and
X⁰ is halogen.

In some embodiments, R⁰ and R⁰⁰ are independently H or alkyl with 1 to 12 C-atoms.

In some embodiments, X⁰ is F, Cl or Br.

In some embodiments, the chemical additive comprises one or more groups capable of chelation, hydrogen bonding, pi-stacking, ionic interactions, dipole interactions, Van der Waals interactions, or any combination thereof.

In some embodiments, the chemical additive interacts with the supramolecular polymer.

In some embodiments, the chemical additive comprises a structural unit selected from the group consisting of:

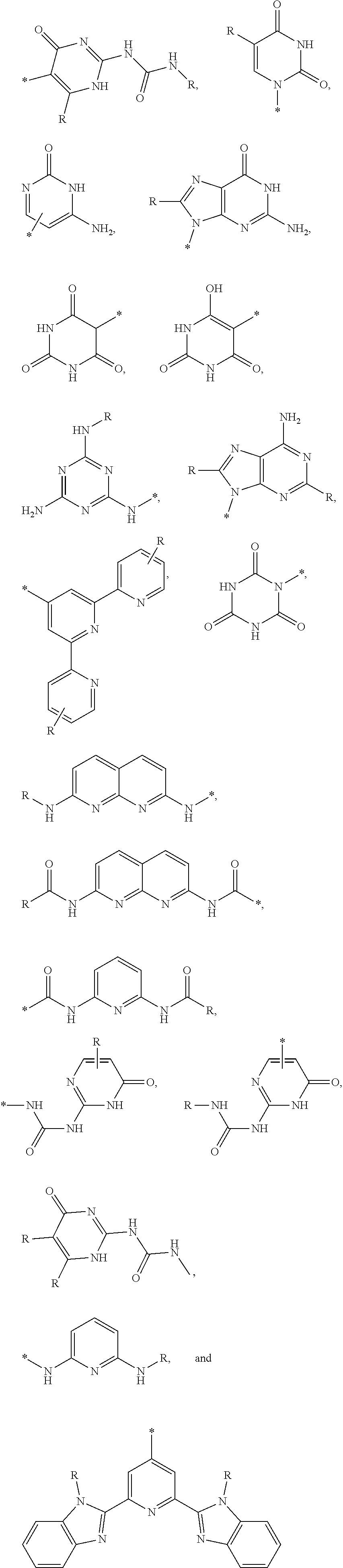

wherein
each R group is independently selected from the group consisting of H, F, Br, Cl, —CN, —NC, —NCO, —NCS, —OCN, —SCN, —C(O)NR⁰R⁰⁰, —C(O)X⁰, —C(O)R⁰, —C(O)OR⁰, —NH₂, —NR⁰R⁰⁰, —SH, —SR⁰, —SO₃H, —SO₂R⁰, —OH, —NO₂, —CF₃, —SF₅, or optionally substituted silyl, carbyl or hydrocarbyl with 1 to 40 C atoms that is optionally substituted and optionally comprises one or more hetero atoms;
each R⁰ and R⁰⁰ are independently H or optionally substituted C₁₋₄₀ carbyl or hydrocarbyl; and
X⁰ is halogen.

In some embodiments, R⁰ and R⁰⁰ are independently H or alkyl with 1 to 12 C-atoms.

In some embodiments, X⁰ is F, Cl or Br.

In some embodiments, the chemical additive modifies solubility.

In some embodiments, the chemical additive comprises a structural unit selected from the group consisting of:

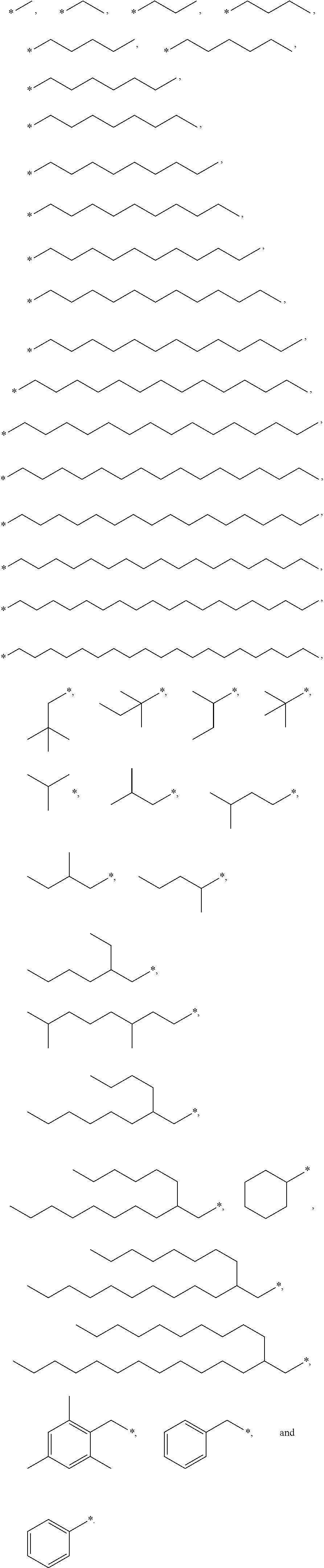

In some embodiments, the chemical additive is selected from the group consisting of:

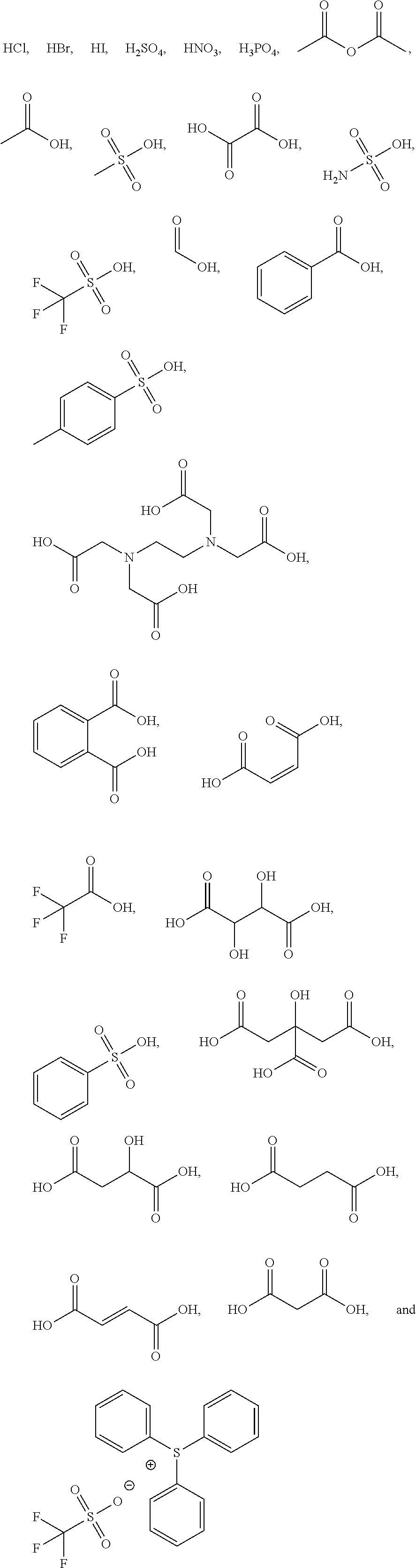

In some embodiments, the chemical additive comprises an inorganic complex.

In some embodiments, the chemical additive comprises an organo-metallic complex.

In some embodiments, the separation mixture does not comprise a supramolecular polymer.

In some embodiments, the performance of the supramolecular polymer is optimized and calibrated reproducibly by measured addition of the chemical additive.

In some embodiments, the invention is related to the separation of single walled carbon nanotubes (SWCNT) by their electronic types (primarily semiconductor enrichment). The type separated, semiconducting SWCNTs, can be used in many downstream applications such as printed electronics, sensors, optoelectronics and solar energy conversion, among other applications.

In some embodiments, the efficiency of separation of semiconducting SWCNTs by a supramolecular polymer is related to the supramolecular polymer's average molecular weight and structural form.

In some embodiments, the average molecular weight, solubility and separation efficiency of a supramolecular polymer stock can be controlled by the intentional addition of ‘spiking agents’. They can also be related or completely unrelated to the structure of the moieties that are part of the supramolecular polymer structure.

In some embodiments, the linear or cyclic structural form affects the separation efficiency of a supramolecular polymer stock which in turn can be controlled by the intentional addition of ‘spiking agents’ including but not limited to those that mimic fully or part of the end groups of the polymer stock. The spiking agents are referred to as ‘end groups’ or ‘stoppers’ or ‘end stopper’, etc. herein.

### BRIEF DESCRIPTION OF THE FIGURES

FIG. 1: Synthesis route of supramolecular polymer (1) used in the separation of SWCNT by electronic types.

FIG. 2: ¹H NMR of supramolecular polymer (1) in CDCl₃ with trace of trifluoroacetic acid.

FIG. 3: UV-Vis-NIR spectra of the dispersions of separated semiconducting SWCNT in toluene. P1-3, P1-4, P2-6 and P1-7 represent different batches of the supramolecular polymer used in the separation method.

FIG. 4: Structure of impurity molecules that can be formed as potential byproducts during the synthesis of the monomer. Since at the final step of the polymer synthesis, two couplings are needed per product molecule, it is theoretically possible to obtain an intermediate (A) in an incomplete reaction. In addition, reductive dehalogenation, a common side reaction in metal-mediated coupling reactions, prior to the desired cross coupling, may result in an impurity molecule B. Those impurities can potentially be quantified by NMR by tracking the signals originating from distinct protons present in the molecules.

FIG. 5: Overlay of the ¹H NMR spectra of two batches of the supramolecular polymer that showed the highest and the lowest separation efficiencies among those screened. Vertical lines are shown through a few of the signals proposed to be assignable to end group moieties. Signal intensities are represented in arbitrary units. For quantifying the impurity presence, signal integration was carried out on the original data as described in paragraphs [0114] and [0115].

FIG. 6: Correlation between the extraction efficiency of a given batch of supramolecular polymer, measured as the concentration of separated semiconducting SWCNT by UV-Vis-NIR absorbance, versus the total percentage of hydrogens in the NMR spectra, proposed to be attributable to the end group moieties of the polymeric chains or standalone impurities of closely resembling structure.

FIG. 7: The DOSY spectrum of two different polymer batches P1-3 and P2-4 (Overlaid) using a 700 MHz Bruker Avance Nuclear Magnetic Resonance spectrometer at 298 K. It is zoomed in to the region showing chemical shifts of methyl groups of each polymer (chemical shifts=2.65 ppm, 6H from two methyl groups, shown as circled on the inset molecular structure). The polymeric batch P1-3 with larger separation efficiency showed a larger diffusion constant and suggesting a relatively smaller average molecular weight compared to P2-4.

FIG. 8: UV-Vis-NIR spectra showing variations in the extraction efficiency measured as the concentration of separated semiconducting SWCNT of a given batch of supramolecular polymer, when spiking agent C (structure shown as inset) is used in different amounts as shown.

FIG. 9A-B: Compound B (see FIG. 4) as opposed to compound C (see FIG. 8) as an end capping reagent could increase the relative abundance of the fluorene subunit, particularly at lower molecular weight. Based on the proposed role of fluorene as being the moiety which interacts and ‘selects’ the semiconducting SWCNT, the performance potential of a supramolecular polymer containing or spiked with B could be significantly improved as compared to a supramolecular polymer containing or spiked with C. In the same way, the relative abundance of fluorene would be increased using A (see FIG. 4) as opposed to C.

FIG. 10: Schematic illustration of tuning supramolecular polymer conformation via chain stoppers. Light gray denotes the supramolecular polymer while dark gray denotes the chain stopper.

FIG. 11: Schematic illustration of ring-chain equilibrium of the UPy-based supramolecular polymer.

FIG. 12: Measured diffusion constants as a function of monomer concentration. Two distinct regions can be observed with a transition at c=10 mM. All values are normalized to the diffusion constant of tetramethylsilane (TMS).

FIG. 13: Bayesian transformation of DOSY data at c=5.3 mM. The diffusion constant is plotted along the vertical axis, while ¹H chemical shifts are plotted along the horizontal axis.

FIG. 14: Bayesian transformation of DOSY data at c=14.9 mM. The diffusion constant is plotted along the vertical axis, while ¹H chemical shifts are plotted along the horizontal axis.

FIG. 15: Modeled ring and chain fractions as a function of monomer concentration (K=6×10⁻⁷ M⁻¹, EM₁=1 mM). Ring and chain fractions are equivalent at c=2.5 mM, which represents the modeled critical concentration.

FIG. 16: Effect of the modeling parameter EM₁ (effective molarity of the monomeric ring) on the calculated critical concentration value in chloroform.

FIG. 17: Bayesian transform of diffusion-ordered NMR data for c=14.9 mM and xₛₜₒₚₚₑᵣ=0.72. Inset—partial chemical structure of the monomer. The diffusion constant (D) is plotted along the vertical axis, while ¹H chemical shifts are plotted along the horizontal axis. The trace left of the plot is the integrated sum of ¹H signals from all protons as a function of D, and shows three distinct peaks (1, 2, and 3). The trace above the plot is the ¹H NMR spectra of the sample, with peaks labeled according to the inset. The monomer peaks are labeled in black, while the corresponding hydrogens from the stopper are labeled in gray italics.

FIG. 18: Bayesian transformation of DOSY data at c=14.9 mM and xₛₜₒₚₚₑᵣ=0.17. The diffusion constant is plotted along the vertical axis, while ¹H chemical shifts are plotted along the horizontal axis. Peaks highlighted in gray are exclusive to the stopper.

FIG. 19: Variable-temperature (VT) NMR of the supramolecular polymer in chloroform. Peak sharpening can be observed as the temperature is increased or decreased.

FIG. 20: Heteronuclear multiple bond correlation (HMBC) spectrum of the supramolecular polymer. Inset—partial structure of the supramolecular monomer. Relevant ¹³C chemical shifts are labeled in gray, while the relevant hydrogen atoms are labeled as H¹, H², and H³.

FIG. 21: ¹H NMR of the supramolecular polymer at different concentrations (left) and c=4.1 mM with different stopper mole fractions (right).

FIG. 22: Solution SAXS spectra of the supramolecular polymer (c=0.2 mM) in toluene with xₛₜₒₚₚₑᵣ=0.66.

FIG. 23: Radius of gyration of the supramolecular polymer in toluene as a function of xₛₜₒₚₚₑᵣ, extracted from solution small-angle X-ray scattering data.

FIG. 24: Modeled ring-chain equilibrium of the supramolecular polymer in toluene with a critical concentration around c≅26 mM. Model inputs were K=6×10⁻⁸ M⁻¹ and EM₁=1 mM.

FIG. 25: UV-vis spectra of the supramolecular polymer and stopper showing no overlap of absorbance peaks. The peak at 400 nm was used to calculate the hyperchromicity of the supramolecular polymer.

FIG. 26: Absorbance of the supramolecular polymer as a function of xₛₜₒₚₚₑᵣ in toluene.

FIG. 27: Temperature-dependent hyperchromicity of the supramolecular polymer with varying mole fractions of stopper. Hyperchromicity (increase in absorbance with temperature) is evident at low values of xₛₜₒₚₚₑᵣ but cannot be observed at high values of xₛₜₒₚₚₑᵣ.

FIG. 28: Absorbance of the supramolecular polymer as a function of xₛₜₒₚₚₑᵣ in chloroform.

FIG. 29: Yield and purity (ϕ) of SWCNTs sorted in toluene as a function of xₛₜₒₚₚₑᵣ.

FIG. 30: Integrated intensity of SWCNTs dispersed in chloroform as a function of xₛₜₒₚₚₑᵣ.

FIG. 31: Free energy of solvation as a function of the fraction of polymer coverage for a range of SWCNT and polymer solubilities. A high ΔG_{CNT-solvent}/ΔG_{polymer-solvent} indicates that SWCNT solubility is poor relative to polymer solubility, and vice-versa. For solvents with a high ΔG_{CNT-solvent}/ΔG_{polymer-solvent}, e.g., toluene, a high fraction of polymer coverage is required to solvate the SWCNT-polymer complex. For solvents with a low ΔG_{CNT-solvent}/ΔG_{polymer-solvent}, e.g., chloroform, a lower fraction of polymer coverage can still result in solvation of the SWCNT-polymer complex.

FIG. 32: Effect of TFA on SWCNT sorting. Careful selection of the TFA/monomer ratio can improve the sorting yield without compromising the purity (ϕ) of sorted SWCNTs. Yield and purity are plotted against the molar ratio of TFA and monomer (TFA/monomer) rather than the molar fraction of TFA and monomer (x_{TFA}) due to the logarithmic progression of TFA amounts.

FIG. 33: UV-vis spectra of SWCNTs sorted at different values of xₛₜₒₚₚₑᵣ.

FIG. 34: Length histograms of SWCNTs sorted at different values of xₛₜₒₚₚₑᵣ.

FIG. 35: Mobility of field-effect transistors made with SWCNTs sorted at different values of xₛₜₒₚₚₑᵣ.

FIG. 36: Without limitation, a monomer unit or stopper molecule of the macromolecular entity used to sort SWCNT by electronic types may use zero, one or more of the many different moieties shown in the figure, in any combination and in any order, to interact with the SWCNT. Asterisks indicate the points of covalent connectivity with the remainder of the SWCNT sorting monomeric species. R groups are defined on each occurrence identically or differently as H, F, Br, Cl, —CN, —NC, —NCO, —NCS, —OCN, —SCN, —C(O)NR⁰R⁰⁰, —C(O)X⁰, —C(O)R⁰, —C(O)OR⁰, —NH₂, —NR⁰R⁰⁰, —SH, —SR⁰, —SO₃H, —SO₂R⁰, —OH, —NO₂, —CF₃, —SF₅, or optionally substituted silyl, carbyl or hydrocarbyl with 1 to 40 C atoms that is optionally substituted and optionally comprises one or more hetero atoms. R⁰ and R⁰⁰ are independently of each other H or optionally substituted C₁₋₄₀ carbyl or hydrocarbyl, and preferably denote H or alkyl with 1 to 12 C-atoms. X⁰ is halogen, preferably F, Cl or Br.

FIG. 37: Without limitation, a monomer unit or stopper molecule of the macromolecular entity used to sort SWCNT by electronic types may use zero, one or more of the many different moieties shown in the figure, alone or in any combination and in any order, as hydrogen bonding side arms of the monomeric unit. Without limitation, such interaction may be based on chelation, hydrogen bonding, pi-stacking, ionic interactions, dipole interactions, Van der Waals interactions, or any combination of these. Modes of interaction include but are not limited to dimerization, trimerization, oligomerization, polymerization, and the opposite of these transformations, resulting from changes in environmental conditions including but not limited to pH, temperature, exposure to light or the absence of light, exposure to sonication or sound, exposure to a voltage differential, and/or exposure to a particular chemical additive or solvent. Asterisks indicate the point of covalent connectivity with the remainder of the SWCNT sorting monomeric species. R groups are defined on each occurrence identically or differently as H, F, Br, Cl, —CN, —NC, —NCO, —NCS, —OCN, —SCN, —C(O)NR⁰R⁰⁰, —C(O)X⁰, —C(O)R⁰, —C(O)OR⁰, —NH₂, —NR⁰R⁰⁰, —SH, —SR⁰, —SO₃H, —SO₂R⁰, —OH, —NO₂, —CF₃, —SF₅, or optionally substituted silyl, carbyl or hydrocarbyl with 1 to 40 C atoms that is optionally substituted and optionally comprises one or more hetero atoms. R⁰ and R⁰⁰ are independently of each other H or optionally substituted C₁₋₄₀ carbyl or hydrocarbyl, and preferably denote H or alkyl with 1 to 12 C-atoms. X⁰ is halogen, preferably F, Cl or Br.

FIG. 38: Without limitation, a monomer unit or stopper molecule of the macromolecular entity used to sort SWCNT by electronic types may use zero, one or more of the many different moieties or similar in functionality shown in the figure alone or in any combination and in any order, to give desirable solubility properties to interact with the SWCNT. Other solubilizing groups may include atoms other than carbon such as oxygen, nitrogen and sulfur. Asterisks indicate the points of covalent connectivity with the remainder of the SWCNT sorting monomeric species.

FIG. 39: Without limitation, the polymer separation process may further incorporate other external additives that are not necessarily part of the monomer molecular structure. These may include but are not limited to acids, photoacid generators, bases, photobase generators, solvents, or other molecules having a pi-system or some hydrogen bonding capability. Such additives may function as end capping agents. Without limitation, such additives may act on the solubility of the overall formulation, the interaction with the SWCNT, or the interaction of the SWCNT sorting monomer or end capping agents with themselves or each other. Such additives may respond in a desirable way to an outside stimulus including but not limited to light, heat, vibration, pH, voltage differential, and/or exposure to a particular chemical additive or solvent. Some examples of such possible additives are shown.

### DETAILED DESCRIPTION OF THE INVENTION

To achieve separation and purification of SWCNT by electronic types, various methods have been investigated and proposed. Of particular interest are polymer-based separation methods that have demonstrated yields >20%, processing times within an hour, and semiconducting purities >99.99%. Some examples for such methods are described in Qiu, S.; Wu, K.; Gao, B.; Li, L.; Jin, H.; Li, Q. Solution-Processing of High-Purity Semiconducting Single-Walled Carbon Nanotubes for Electronics Devices. Adv. Mater. 2018, 1800750; Lefebvre, J.; Ding, J.; Li, Z.; Finnie, P.; Lopinski, G.; Malenfant, P. R. L. High-Purity Semiconducting Single-Walled Carbon Nanotubes: A Key Enabling Material in Emerging Electronics. Acc. Chem. Res. 2017; Wang, H.; Bao, Z. Conjugated Polymer Sorting of Semiconducting Carbon Nanotubes and Their Electronic Applications. Nano Today 2015, 10 (6), 737-758; and Lei, T.; Pochorovski, I.; Bao, Z. Separation of Semiconducting Carbon Nanotubes for Flexible and Stretchable Electronics Using Polymer Removable Method. Acc. Chem. Res. 2017, 50 (4), 1096-1104; and references therein (each incorporated by reference in its entirety).

As can be seen from the above, most of the polymers used in the type separation of SWCNT themselves are high value electronic materials, often the single largest contributors to the cost of the separation. Further, the separation is achieved by the wrapping of a first monolayer of the polymer on the surface of the SWCNT, which is very difficult to remove in subsequent steps.

Removal of the sorting polymer from the sorted population of SWCNT is necessary for attaining superlative device performance, as the presence of excess sorting polymer in SWCNT electronics is known to degrade important device metrics such as current density, on-off ratio, and charge carrier mobility, among other key performance metrics needed for practical, industrial applications. Such effects are disclosed in Yu, X.; Liu, D.; Kang, L.; Yang, Y.; Zhang, X.; Lv, Q.; Qiu, S.; Jin, H.; Song, Q.; Zhang, J.; et al. Recycling Strategy for Fabricating Low-Cost and High-Performance Carbon Nanotube TFT Devices. ACS Appl. Mater. Interfaces 2017, 9 (18), 15719-15726; Joo, Y.; Brady, G. J.; Kanimozhi, C.; Ko, J.; Shea, M. J.; Strand, M. T.; Arnold, M. S.; Gopalan, P. Polymer-Free Electronic-Grade Aligned Semiconducting Carbon Nanotube Array. ACS Appl. Mater. Interfaces 2017, 9 (34), 28859-28867; Gao, T. Z.; Lei, T.; Molina-Lopez, F.; Bao, Z. Enhanced Process Integration and Device Performance of Carbon Nanotubes via Flocculation. Small Methods 2018, 2 (10), 1800189; Li, Z.; and Ding, J.; Guo, C.; Lefebvre, J.; Malenfant, P. R. L. Decomposable S—Tetrazine Copolymer Enables Single-Walled Carbon Nanotube Thin Film Transistors and Sensors with Improved Sensitivity. Adv. Funct. Mater. 2018, 28 (13), 1705568 (each incorporated by reference in its entirety). Further, due to the high cost of the sorting polymers, separation pathways that allow for the complete recycling of the spent polymer are critical for keeping the cost of separations down.

Bao and Pochorovski have demonstrated a method wherein a supramolecular polymer with the monomeric units held together by reversible hydrogen bonding can be used to separate SWCNT by electronic types in a closed loop fashion. Details of their method were described in the United States patent application publication US 2016/0280548 titled Isolating Semiconducting Single-Walled Nanotubes or Metallic Single-Walled Nanotubes and Approaches Therefor (hereby incorporated by reference in its entirety).

A supramolecular polymer is disclosed for the purpose of SWCNT electronic separation to include a plurality of monomer units that are non-covalently linked to form the supramolecular polymer. The monomer units are made up of terminal ureido pyrimidinone (UPy) moieties, carbon side-chains, and an unspecified moiety in between the terminal UPy moieties. In various specific embodiments, the unspecified moiety in between the terminal UPy moieties includes a fluorene moiety, a thiophene moiety, a benzene moiety, a benzodithiophene moiety, a carbazole moiety, thienothiophene moiety, perylene diimide moiety, a isoindigo moiety, a diketopyrrolopyrrole moiety, a enantiopure binaphthol moiety and an oligomer or combination of two or more of the above moieties. See, e.g., US 2016/0280548 (hereby incorporated by reference in its entirety).

A general process for the separation of SWCNT by electronic types is disclosed, including steps like: The addition of the supramolecular polymer to a SWCNT mixture to form a mixture of non-dispersed SWCNTs of the undesired electrical type and non-dispersed supramolecular polymer, and a dispersed complex that includes the SWCNTs of the desired electrical type and the supramolecular polymer; Removal of the non-dispersed SWCNTs of the undesired electrical type (and the non-dispersed supramolecular polymer) from the dispersed complex, such as by centrifuging and/or filtering the mixture; Addition of a bond disrupting agent to disassemble the supramolecular polymer in order to release the SWCNTs of the desired electrical type from the supramolecular polymer. See, e.g., US 2016/0280548 (hereby incorporated by reference in its entirety).

The dependence of purity and yield of the isolated SWCNT of the desired electrical type on dispersion parameters is also disclosed. The dispersion parameters include settings related to the sonication and/or centrifugation. Example dispersion parameters include a ratio of the supramolecular polymer to SWCNT mixture, concentration of the SWCNTs, sonication power used during the dispersion, and sonication time, among other parameters, such as centrifugation parameters that include speed, temperature, and time of centrifugation. The dispersion parameters can be varied, in various embodiments, to adjust the properties of the isolated SWCNTs. For example, the dispersion parameters can be adjusted to select the purity and/or yield of the SWCNT dispersion (e.g., the isolated SWCNTs of the desired electrical type). In various specific embodiments, the purity of the separated SWCNT population is further optimized by varying the ratio of supramolecular polymer to SWCNT mixture. See, e.g., US 2016/0280548 (hereby incorporated by reference in its entirety).

Regardless of tight control on the conditions of the experiments, the present inventors recorded an important observation, viz the significant change in the separation efficiency when different polymer batches were used to type separate the same set of starting SWCNT populations under identical conditions of separation and the polymer-SWCNT ratios. Hence, the chemical purity of the polymeric batches involved were subject to intense scrutiny.

The inventors further observed to their surprise that polymeric batches displaying features (as observed in the 1D NMR spectra) that are generally considered as ‘impurities’ registered a larger separation efficiency compared to the relatively ‘purer’ batches of polymer.

The inventors further assigned some of the NMR spectral features recognized as ‘impurities’ to one, or more than one structure of end group moiety, showing a positive correlation between the mole ratio of the end group moiety assignments in comparison to the separation efficiencies.

To support the observations further, an early DOSY study of the diffusion coefficient of the polymeric chains indicated a lower molecular weight for the polymeric batch that showed a higher separation efficiency.

In order to control and improve the SWCNT electronic-type separation efficiency of a given batch of supramolecular polymer, further embodiments were initiated wherein small quantities of a given end group moiety (also referred to as ‘stopper molecules’ or ‘stoppers’ in this specification throughout) were added to the starting mixture composed of a solvent, supramolecular polymer and SWCNTs, resulting in increased separation efficiencies. The process of adding additional end group moieties is also referred to as ‘spiking’ in this specification throughout.

The inventors further noticed the polymeric system in a given solvent at a given temperature exists in an equilibrium state between two structural forms of the polymer, viz., cyclic (or ‘ring’) and a linear (or ‘chain’) forms and observed through careful experimentation that separation efficiencies can further be increased by shifting the equilibrium between the ring and chain forms by the external addition of the end group moiety to the starting mixture composed of a solvent, supramolecular polymer and SWCNTs.

Regardless of the different possible end group moieties or ‘stoppers’ used for spiking to increase separation efficiencies, the structural forms of the supramolecules present or the mechanisms of separations that are possible, the inventors concluded that the systematic molecular engineering of the end stopper moieties in a supramolecular polymer system is a method to exploit the efficiency of separation of semiconducting SWCNT from a mixed population of semiconducting and metallic SWCNTs. The details of different experiments and characterization methods are further described in the following sections of this specification.

Single walled carbon nanotubes (SWCNT) are seamlessly rolled graphene sheets with diameters in nanoscale dimensions and lengths ranging from few nanometers to several ten microns. A given SWCNT exhibits an optoelectronic and electronic behavior (i.e., semiconducting or metallic) dependent on the roll-up vector and the final diameter. Various synthesis methods such as Laser evaporation, Arc Discharge, Chemical Vapor Deposition (CVD), High pressure carbon monoxide (HipCO) and combustion have been employed for lab scale and/or production scale synthesis of the SWCNT. The nature of the catalyst metal and non-tubular carbon impurities change widely from method to method. The relative ratio of the semiconducting SWCNT and metallic SWCNT vary as well dependent on the method. In general, gas phase synthesis of SWCNT by most methods results in a relative ratio of 2:1 for the semiconducting to the metallic types. Throughout this specification, terms like nanotubes, CNTs, SWCNT, and SWCNTs refer to single walled carbon nanotubes regardless of the method of synthesis, nature of impurities, diameter or length distribution.

In various embodiments as described herein, chain stoppers were utilized to control the conformation and degree of polymerization of a supramolecular polymer to improve SWCNT sorting. Using NMR spectroscopy and modeling, it was determined that this supramolecular polymer exhibited ring-chain equilibrium in chloroform, and that the conformation distribution can be moderated by chain stoppers. Using SAXS and UV-vis spectroscopy, it was found that ring-chain equilibrium also occurred in toluene, the solvent used for SWCNT sorting. It has been demonstrated that the addition of stopper allows for the sorting yield to be doubled without compromising the purity or properties of sorted SWCNTs.

Based on the experimental observations presented herein, various additional embodiments are included for increasing the selectivity and/or semiconducting SWCNT separation efficiency of the starting polymeric stock by intentional addition of carefully selected impurities. Without limitation, such an addition is aimed at enhancing the selectivity and/or efficiency of the separation process by shifting the average molecular weight and/or polydispersity of the starting polymeric stock or modifying the structural form of the starting polymeric stock or a combination of any of those. Such willful addition of controlled amounts of carefully selected impurity molecules or other listed compounds is variously referred to in this specification as addition of ‘end cap moiety’ or ‘end capping agents’ or ‘end group molecules’ or ‘end group moieties’ or ‘chemical additives’ or ‘additives’ or ‘stopper molecules’, or stoppers or ‘spiking agents’. All of the terms being used interchangeably throughout this specification, the process of such addition during any stage of the SWCNT electronic type separation process can be referred to simply as ‘spiking’.

Based on the experimental observations presented herein, various stopper molecules can be added to the separation mixture at any stages of the SWCNT electronic type separation process for improving the selectivity and/or efficiency of the separation process yielding a larger fraction of semiconducting SWCNT with increasing purity. Such additives are not limited to the molecular structures resembling the moieties of the supramolecular polymer, but rather can be organic molecular structures deviating far away from those structures. Optionally, additives may incorporate inorganic complexes or organometallic complexes that can slice or recombine the hydrogen bonded supramolecular polymer to shift the average molecular weight, polydispersity, and/or shift the structural conformations.

Further, various stopper molecules can be added to the separation mixture at any of the stages of the SWCNT separation process for preferably separating one or two or few of single walled carbon nanotube of a given chirality (n, m index). Such additives are not limited to the molecular structures resembling the moieties of the supramolecular polymer, but with organic molecular structures possibly deviating far away from those structures. Optionally, additives may incorporate inorganic complexes or organometallic complexes that can slice or recombine the hydrogen bonded supramolecular polymer to shift the average molecular weight, polydispersity, and/or shift the structural conformations.

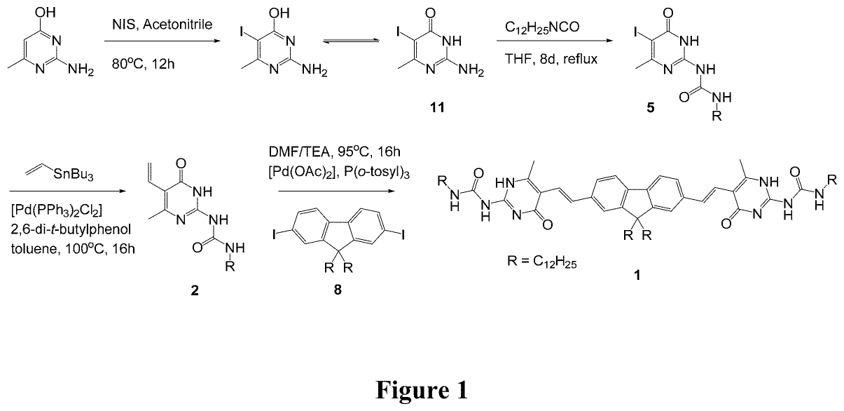

Compound 1 shown in FIG. 1 is the monomer unit of the supramolecule used to separate the SWCNT by electronic types. It incorporates a fluorene in the center and two flanking hydrogen bonding moieties. The central fluorene unit, referred to here as ‘SWCNT selecting unit’ is understood to provide the primary interaction with the SWCNT and provide the ability to interact selectively with metallic or semiconducting SWCNT. The hydrogen bonding moieties (referred to here as ‘polymerization groups’) on either side of the fluorene provide the supramolecule with the ability to polymerize or depolymerize based on the environment, and also the ability to be separated from the type separated SWCNT once the sorting has been accomplished. Finally, the alkyl chains incorporated into the SWCNT selecting unit as well as the polymerization groups, give the polymer/monomer desired solubility properties in solvents such as toluene. These groups are referred to as ‘solubilizing groups’. Accordingly, the following embodiments present possible variations of these three very important chemical functionalities of any stopper molecule or monomer of a supramolecular polymer used to separate SWCNT by electronic types.

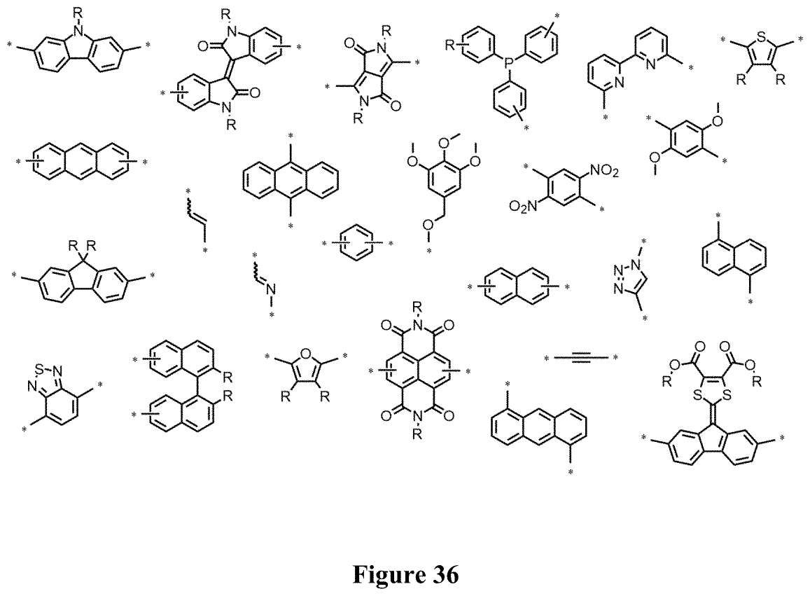

In some embodiments, and without limitation, FIG. 36 shows many different chemical moieties or functional groups that can serve as the ‘SWCNT selecting unit’ described in paragraph [0089]. A monomer and/or stopper molecule of a supramolecular SWCNT sorting polymer may use zero, one or more than one of many different moieties, in any combination, any order and any connectivity, to interact with the SWCNT.

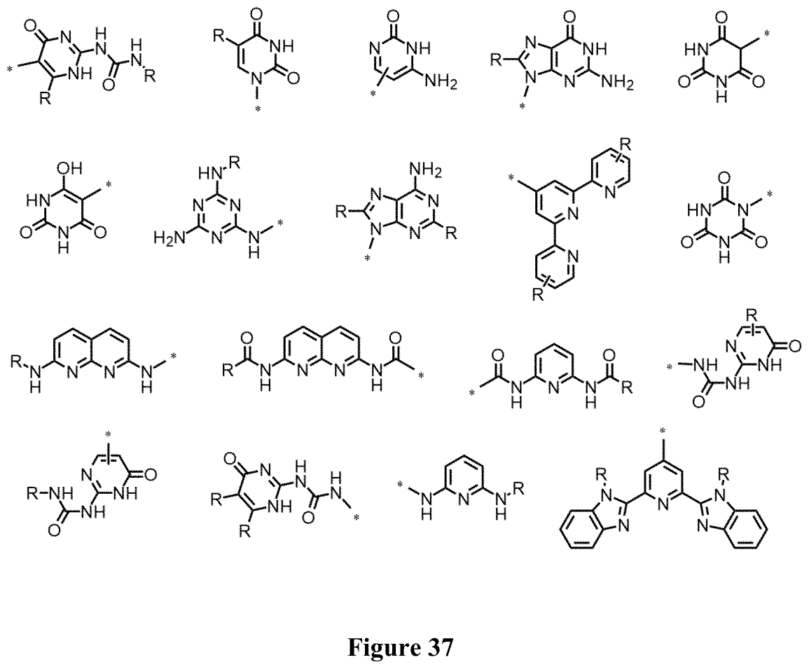

In some embodiments, and without limitation, FIG. 37 shows many different chemical moieties or functional groups that can serve as the ‘polymerization groups’ described in paragraph [0089]. Without limitation, interactions between polymerization groups may be based on chelation, hydrogen bonding, pi-stacking, ionic interactions, dipole interactions, Van der Waals interactions, or any combination of these. Modes of interaction include but are not limited to dimerization, trimerization, oligomerization, polymerization, and the opposite of these transformations, resulting from changes in environmental conditions including but not limited to pH, temperature, exposure to light or the absence of light, exposure to sonication or sound, exposure to a voltage differential, and/or exposure to a particular chemical additive or solvent.

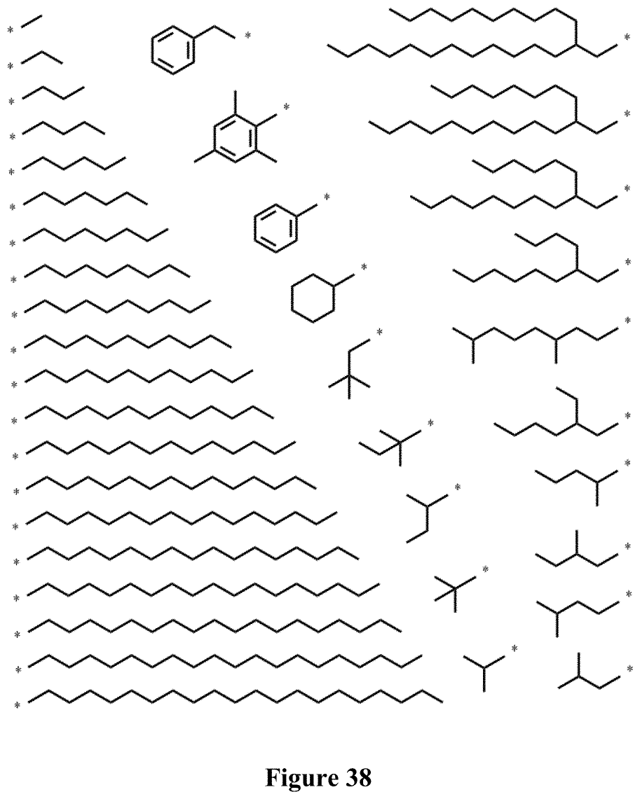

In some embodiments, and without limitation, FIG. 38 shows many different chemical moieties or functional groups that can serve as the side chains or the ‘solubilizing groups’ described in paragraph [0089]. A stopper molecule and/or monomer unit of the macromolecular entity used to sort SWCNT by electronic types may use zero, one or more of the many different moieties or moieties similar in functionality to those shown in the figure, alone or in any combination and in any order, to give desirable solubility properties to interact with the SWCNT. Other solubilizing groups may include atoms other than carbon such as oxygen, nitrogen and sulfur.

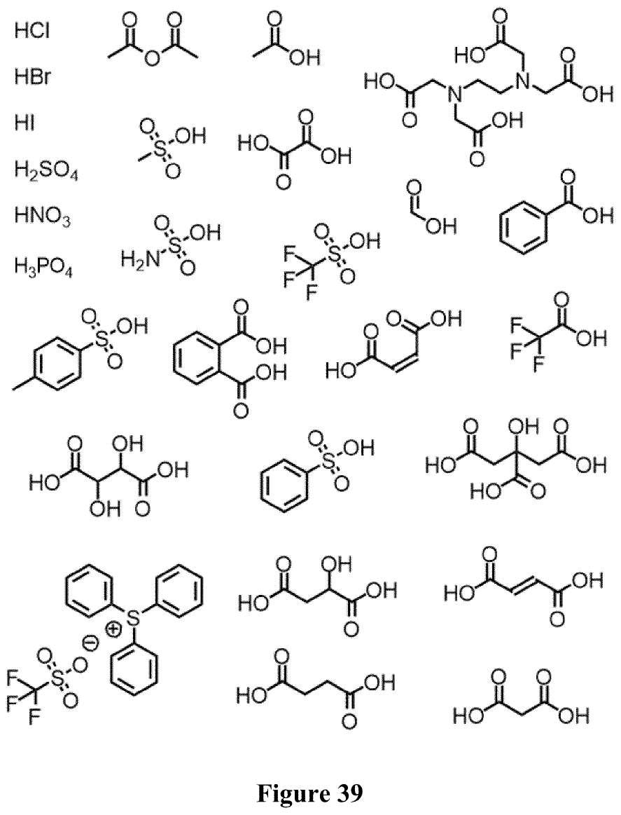

In some embodiments the SWCNT type separation process may involve external additives that are not necessarily related to the three functional parts of the stopper molecules and/or monomer molecular structure described in paragraph [0089]. These may include but are not limited to acids, photoacid generators, bases, photobase generators, solvents, or other molecules having a pi-system or some hydrogen bonding capability. Such additives may themselves function as end capping agents. Without limitation, such additives may act on the solubility of the overall formulation, the interaction with the SWCNT, or the interaction of the SWCNT sorting monomer or end capping agents with themselves or each other. Such additives may respond in a desirable way to an outside stimulus including but not limited to light, heat, vibration, pH, voltage differential, and/or exposure to a particular chemical additive or solvent. Without limitation, some examples of such possible additives are shown in FIG. 39.

In some embodiments, the SWCNT sorting polymer formulation including stopper molecules may be composed of more than one monomer structure and/or more than one stopper molecule structure. This may enhance the selectivity and/or sorting efficiency of the supramolecular polymer.

In some embodiments, the supramolecular SWCNT sorting polymer and/or stopper molecule species may be constructed in such a way as to be stereoisomeric. Stereoisomeric groups may be incorporated into any moiety described above, or connectivity of moieties described above in order to enhance the selectivity and/or sorting efficiency of the supramolecular polymer.

In some embodiments, the monomers and/or stopper molecules of the SWCNT sorting supramolecular polymer may be constructed such that the polymer can have directionality which may enhance the selectivity and/or sorting efficiency of the supramolecular polymer.

In some embodiments, the stopper molecules may demonstrate selectivity and/or sorting efficiency for the sorting of SWCNT without the need for a supramolecular polymer.

In some embodiments, the performance of the SWCNT separating supramolecular polymer could be reproducibly calibrated to optimum performance on a batch to batch basis by the portion wise addition of a stopper molecule to the batch until optimum performance is achieved. High synthetic yields of SWCNT sorting supramolecular polymers can be associated with high purity by NMR, which we have shown to be correlated to poor performance. High synthetic yields and high performance are both desirable. Since a batch having a high yield can be calibrated to high performance by spiking with a stopper molecule, the commercial value may be further increased by this approach. This approach may also be important to ensure batch to batch uniformity.

Those skilled in the art will recognize or be able to ascertain using no more than routine experimentation, many equivalents to the specific embodiments described herein. Such equivalents are intended to be within the scope of the present invention.

The invention is further described by the following non-limiting Examples.

### Examples

Examples are provided below to facilitate a more complete understanding of the invention. The following examples serve to illustrate the exemplary modes of making and practicing the invention. However, the scope of the invention is not to be construed as limited to specific embodiments disclosed in these Examples, which are illustrative only.

The synthesis scheme for the monomer unit of the supramolecular polymer is shown in FIG. 1. The detailed method of synthesis is described in H-Bonded Supramolecular Polymer for the Selective Dispersion and Subsequent Release of Large-Diameter Semiconducting Single Walled Carbon Nanotubes by Pochorovski et al., J. Am. Chem. Soc. 2015, 137, 4328-4331.

Various batches of the polymer in different batch sizes were synthesized following the procedure described above. In one specific example used as part of the present investigation a half gram batch of the monomer was synthesized as below. The numbers shown correspond to the molecular structure shown in FIG. 1.

Synthesis of 11: 2-amino-4-hydroxy-6-methylpyrimidine (13.89 g, 111 mmol) and N-iodosuccinimide (25 g, 111 mmol) in acetonitrile (334 mL) was heated at 80° C. for 12 hours. After cooling to room temperature, the precipitate was collected by filtration, affording 11 (25.38 g) as an off-white solid.

Synthesis of 5: 2-Amino-5-iodo-6-methylpyrimidin-4(3H)-one (11) (12.4 g, 49.4 mmol) was suspended in dry THF (500 mL). Dodecyl isocyanate (20.2 mL, 84.0 mmol) was added, and the mixture was stirred at 90° C. for 8 d. The mixture was cooled to 25° C., the formed precipitate was filtered off, and washed with CH₂Cl₂ to afford compound 5 as a white solid (21.247 g, 93.1%)

Synthesis of 2: Compound 5 (4.0 g, 8.7 mmol), [Pd(PPh₃)₂Cl₂] (304 mg, 433 mmol), and 2,6-di-t-butylphenol (37 mg, 0.17 mmol) were dissolved in toluene (60 mL). Tributyl(vinyl) stannane (3.0 mL, 10 mmol) was added. The mixture was degassed and heated to 100° C. for 16 h. The mixture was filtered hot over a plug of cotton followed by hot filtration over Celite. The obtained yellow-orange solution was cooled to 25° C., resulting in crystal formation. The formed crystals were filtered off, washed with small quantities of toluene, and dried, to afford compound 2 as a white solid (0.9 g, 29%).

Synthesis of 1: Compound 2 (0.7 g, 1.93 mmol) and diiodofluorene 8 (0.655 g, 0.86 mmol) were suspended in a mixture of DMF (41 mL) and TEA (12 mL) under N₂ atmosphere. The mixture was degassed and [Pd(AOc)₂] (19.7 mg, 0.086 mmol) and tri(o-tolyl) phosphine (53.43 mg, 0.173 mmol) were added. The mixture was stirred at 95° C. for 16 h, then filtered hot over glass wool. The bright orange solution was concentrated in vacuo. The remaining solid was dissolved in CHCl₃ (28 mL)/TFA (0.411 mL) and precipitated with MeOH (50 mL). The precipitate was filtered off and washed with MeOH. This reprecipitation procedure was repeated two more times to afford compound 1 (0.485 g, 25% yield) as a yellow solid.

The detailed methods of characterization of the monomer unit of the supramolecular polymer is described in the article, H-Bonded Supramolecular Polymer for the Selective Dispersion and Subsequent Release of Large-Diameter Semiconducting Single Walled Carbon Nanotubes by Pochorovski et al., J. Am. Chem. Soc. 2015, 137, 4328-4331 (herein incorporated by reference in its entirety). Various batches of the polymer synthesized in different batch sizes were characterized following the procedure described above. In one specific example used as part of the present investigation, a typical polymer sample was characterized as below.

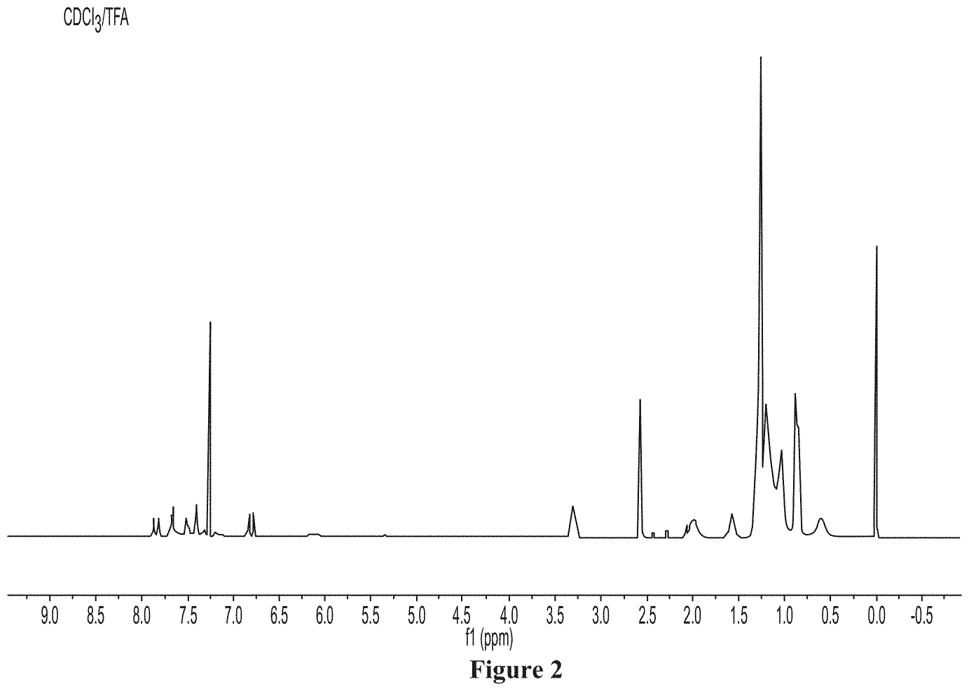

¹H NMR spectra was recorded on a Jeol 300 MHz NMR at 298 K. Deuterated chloroform with small quantities of trifluoroacetic acid were used for internal references. ¹H NMR: CDCl₃/TFA (shown in FIG. 2) δ=0.53-0.74 (m, 4H), 0.86 (dt, J=13.1, 7.0, 12H), 0.96-1.54 (m=72H), 1.72 (s, 4H), 1.95 (d, J=31.6, 4H), 2.49 (s, 6H), 3.33 (s, 4H), 6.98 (d, J=16.4, 2H), 7.40 (s, 2H), 7.47 (s, 2H), 7.64 (d, J=8.3, 2H), 7.81 (d, J=14.9, 2H)

In a separate set of experiments, four batches of the same polymer were synthesized using the process described in paragraphs [0103] to [0107] or a close variant with an aim to synthesize distinct batches (polymer P1-3, polymer P1-4, polymer P1-7, and polymer P2-6) and fully characterized by NMR spectra.

In yet another set of experiments, separation efficiencies of different batches of the supramolecular polymer (polymer P1-3, polymer P1-4, polymer P1-7, and polymer P2-6) were determined by an extraction process described as follows. A 30 mg sample of each polymer was dissolved in dust-free toluene (45 mL), via a 20-minute bath sonication under nitrogen. More dust-free toluene (5 mL) and as-produced SWCNT (17.5 mg) were added to the solution and stirred for 5-10 minutes at 500 RPM. The solution was probe sonicated under nitrogen, in a chilled water bath, using a half-inch diameter tip, set to 30% amplitude for 30 minutes. The solution was then centrifuged at 17,000 RPM for 42 minutes, and the amber-colored supernatant was decanted.

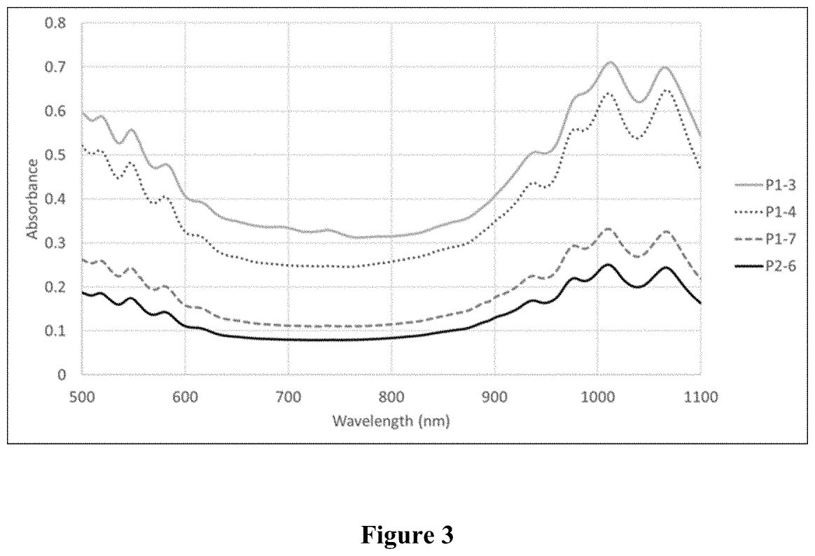

In all the four cases, the UV-Vis-NIR absorption spectra of the separated SWCNT extracts in toluene were recorded using a Shimadzu UV-Vis-Spectrophotometer (Model UV-1601 PC (wavelength range: 190 nm-1100 nm, spectral bandwidth: 2 nm, wavelength accuracy: 0.5 nm)). The spectral traces are shown in FIG. 3. The concentration of the separated, semiconductor SWCNT in the final extract were measured by using the absorbance of the peak closest to 1060 nm wavelength. in each case and thus quantifying the separation efficiency. The higher this absorbance number was under a given set of conditions, the separation efficiency of the polymer batch used were considered proportionately higher.

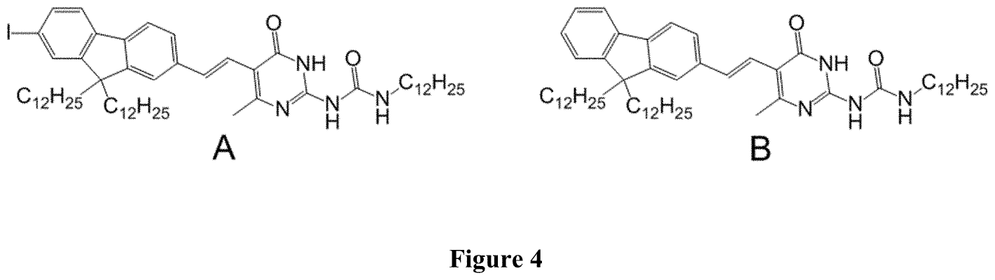

In order to understand the causes for noticeable differences in separation efficiencies, various factors were looked at including the phase purity of the starting polymeric stock. Since at the final step of the polymer synthesis, two couplings are needed per product molecule, it is therefore theoretically possible to obtain an intermediate A (FIG. 4), as an impurity if the reaction is not driven to completion. In addition, reductive dehalogenation is a common side reaction in metal-mediated coupling reactions. A reductive dehalogenation prior to the desired cross coupling, may also result in an impurity molecule B (FIG. 4). Those kinds of impurities can potentially be quantified by NMR by tracking the signals originating from distinct protons present in the molecules. A procedure used in the current set of experiments is described in the next paragraphs.

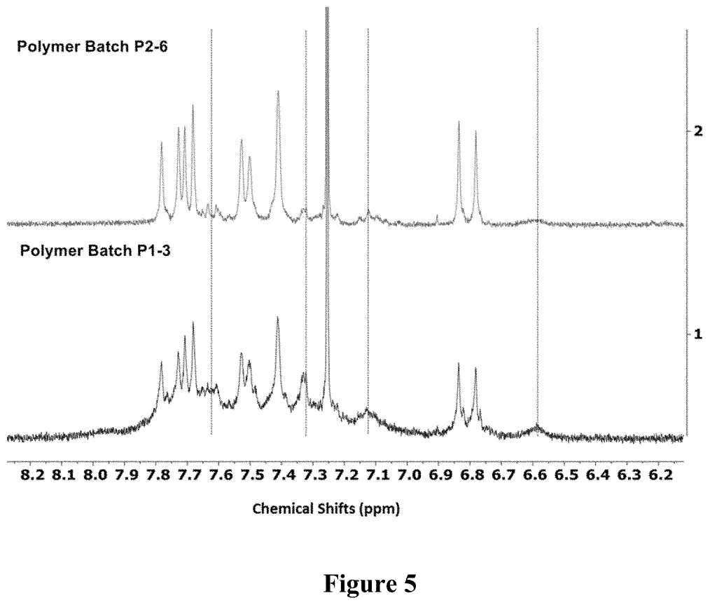

The ¹H-NMR spectra of the different polymeric batches P1-3, P1-4, P1-7 and P2-6 in toluene, mixed with TFA were recorded as described earlier and carefully analyzed. FIG. 5 shows as an example the 1-D ¹H NMR spectra of compounds P2-6 and P1-3, which showed the widest difference in terms of separation efficiencies. Key NMR features proposed to be assigned to protons originating from the end group moiety (molecular structures A and/or B) are marked with vertical lines.

The NMR spectra shown in FIG. 5 are of supramolecular polymer batches that have been depolymerized by TFA. The NMR spectra of the monomer of the supramolecular polymer and end caps impurities can be similar, and since there can be more than one end cap impurity (such as A and B in FIG. 4) there can be some overlap of signals. Nevertheless, the ratio (as a %) of the sum of the integrated intensities of the end group or impurity features with respect to the total integrated aromatic features for each batch were determined as a relative quantitative measure of the end group features in the monomers of the supramolecular polymeric sample used for semiconductor SWCNT separation.

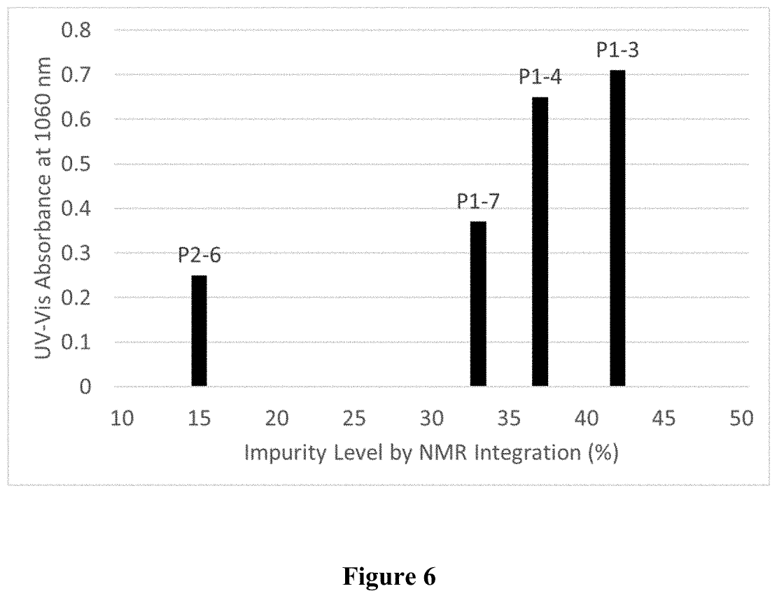

FIG. 6 shows the correlation between the semiconductor SWCNT separation efficiencies and the concentration of the end group/impurity moieties for all four samples that were analyzed. Surprisingly and counter intuitively, the separation efficiency of the polymer as determined by UV-vis-NIR absorbance was found to be directly proportional to the relative amount of end moiety or impurity concentration (as determined by NMR) present in the polymer rather than being directly proportional to the purity of the starting polymeric stock as expected.

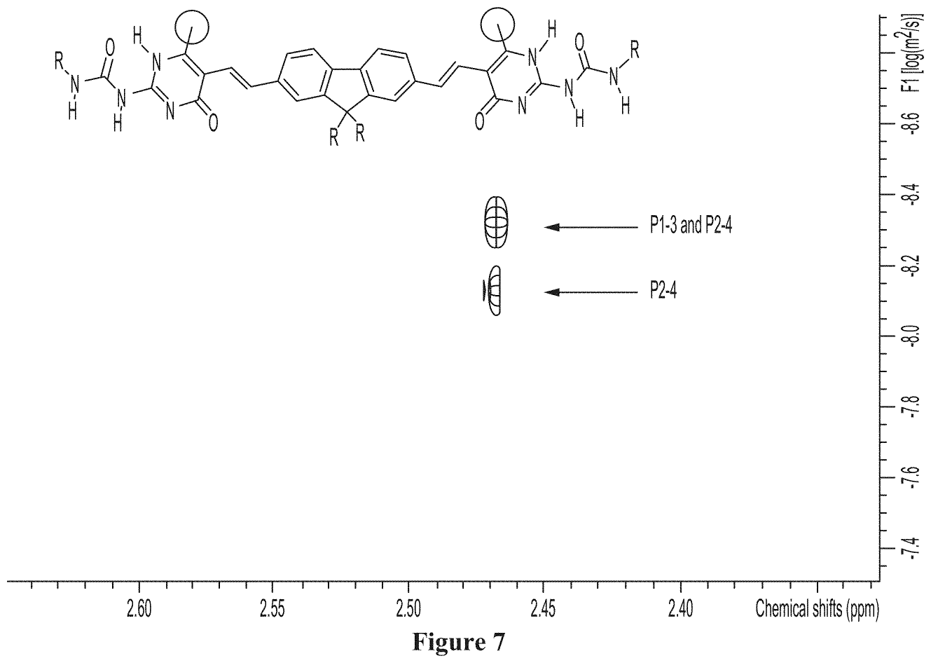

The role of the distribution of the chain lengths of the starting polymeric stock as reflected by the average polymer molecular weights on the separation efficiencies were investigated in yet another set of experimentation. Polymer molecular weight distributions of two different samples of differing SWCNT separation efficiencies (P1-3 and P2-4; similar to P2-6 in separation efficiency) were investigated using 2D DOSY NMR (Diffusion Ordered Spectroscopy) spectroscopy using a 700 MHz Bruker Avance Nuclear Magnetic Resonance spectrometer at 298 K. Variation in the NMR shift as a function of magnetic field gradient were determined for the two batches and the diffusional constants for the two polymers were derived from that data using standard methods. FIG. 7 shows the zoomed-in region corresponding to the chemical shifts of the methyl groups of each polymer (chemical shifts=2.65 ppm, 6H from two methyl groups, shown as circled on the inset molecular structure).

The polymeric batch P1-3 with larger separation efficiency showed a larger diffusion constant and suggested a relatively smaller average molecular weight compared to P2-4. This observation is central to the idea that the average molecular weight of the supramolecular polymer can play an important role in increasing the separation efficiency of the polymer and can be modified and controlled.

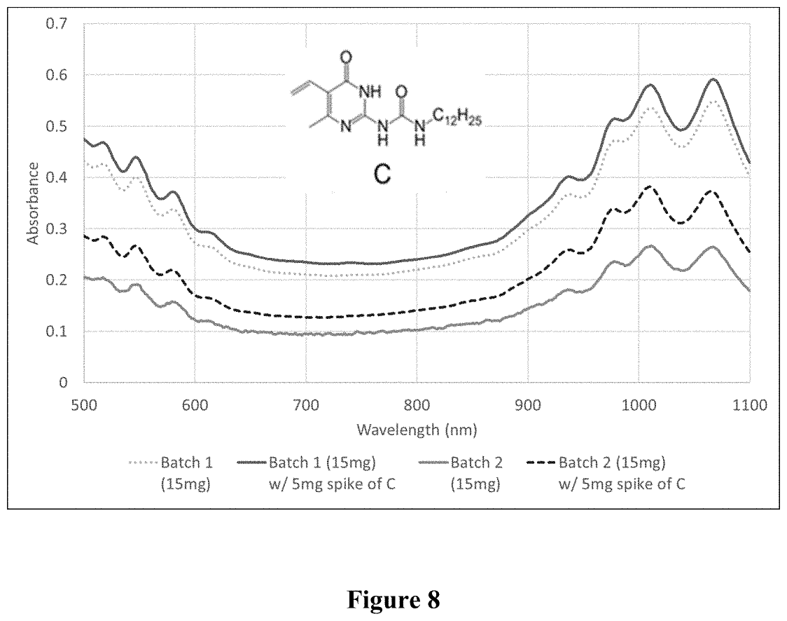

The experimental observations above suggested that the end group moiety or a molecule closely resembling the structure of the end group moiety can be introduced as a deliberate impurity to increase the SWCNT type separation efficiency. To confirm this, in a separate set of experiments, compound C (shown as inset of FIG. 8), was used as a deliberate impurity additive during a normal separation in two separate sets of experiments (Batch 1 and Batch 2). Addition of the end cap compound (C) to the separation mix always resulted in noticeable increase in separation efficiencies. We also observed that the effect had a plateau for end capping reagent C, such that performance of the SWCNT separation polymer did not continue to increase beyond a certain concentration of added C. It was further noted that different batches having different starting performances gave different peak separation efficiency when compound C was added as a spiking impurity. This is proposed to be due to the variable amounts of other end cap reagents, such as A or B, already in the different batches at different concentrations. If the potency of A or B or some other end cap is greater than or different from that of C, the impact and possible plateau of performance due to added C may be altered or overshadowed.

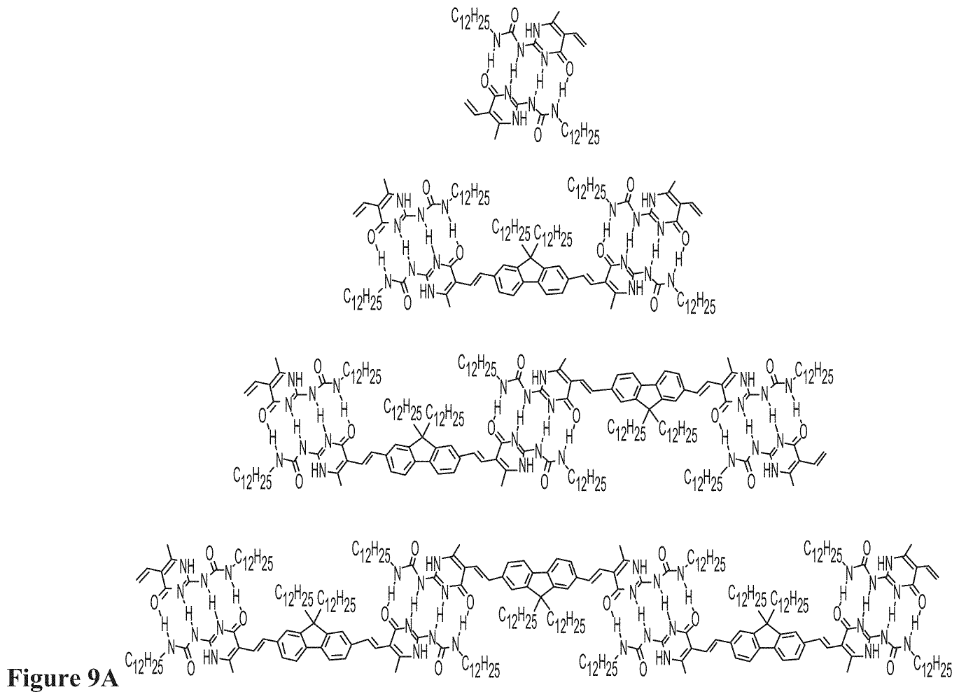

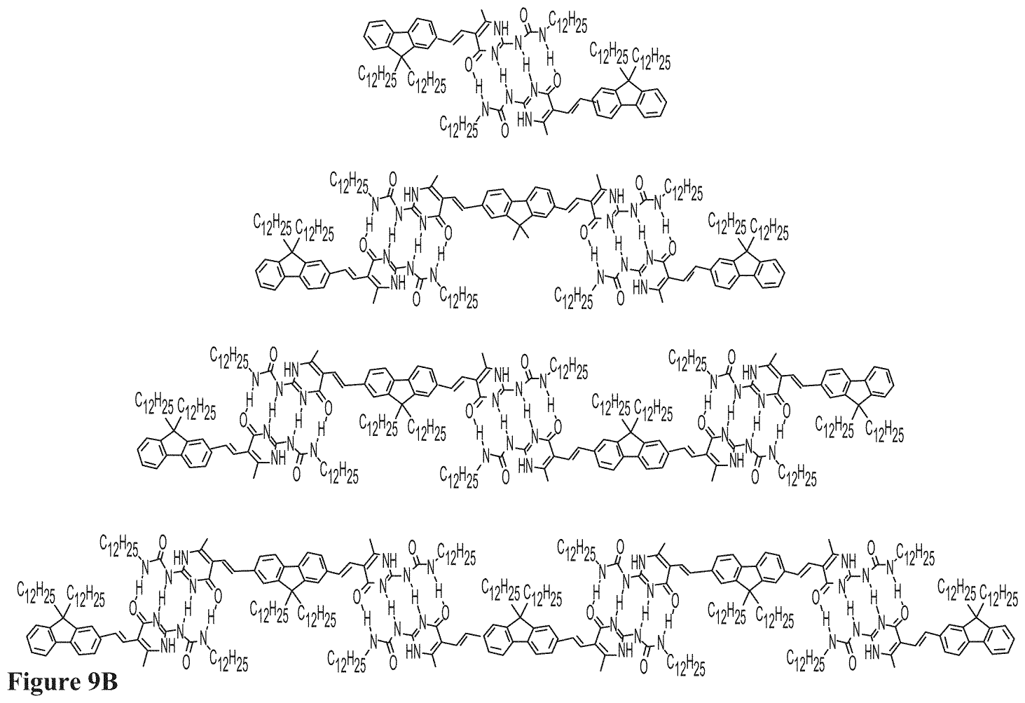

As one possible explanation for the effects described above, compound B (see FIG. 4) as opposed to compound C (see FIG. 8) as an end capping reagent could increase the relative abundance of the fluorene subunit, particularly at lower molecular weight (see FIG. 9A-B for visualization). Based on the proposed role of fluorene as being the moiety which interacts and ‘selects’ the semiconducting SWCNT, the performance potential of a supramolecular polymer containing or spiked with B could be significantly improved as compared to a supramolecular polymer containing or spiked with C. In the same way, the relative abundance of fluorene would be increased using A (see FIG. 4) as opposed to C.

In addition to the modification of average molecular weights and/or polydispersity, which may serve to enhance the selectivity and/or efficiency of the SWCNT separation process by improving the steric properties, electronic properties, kinetic behavior, or topographical alignment of the starting polymeric stock, or by increasing the solubility (attainable concentration) of the starting polymeric stock, or a combination of any of those, spiking the polymer stock with the end cap/stopper molecule as described in the previous paragraphs can be used to control the structural forms in which the supramolecular polymer can exist in solution. Shifting of equilibrium between ring and chain forms in a desired way can also be used to control the separation efficiency for achieving higher yields or even selectively enriching a given chiral type (n,m) of nanotube or given diameter range or a nanotube of selective diameter from among a starting population of assorted types of single walled carbon nanotubes. Experimental examples, and various control factors and embodiments related in particular to the ring-chain structural control of the supramolecular polymer are described in the following paragraphs.

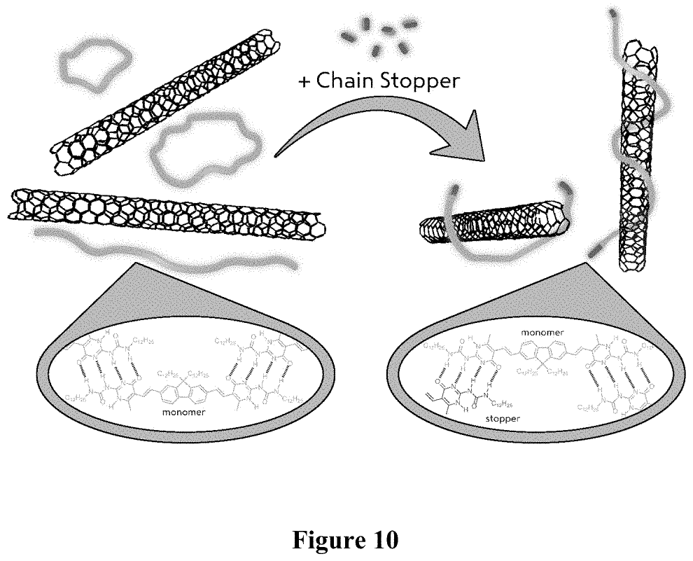

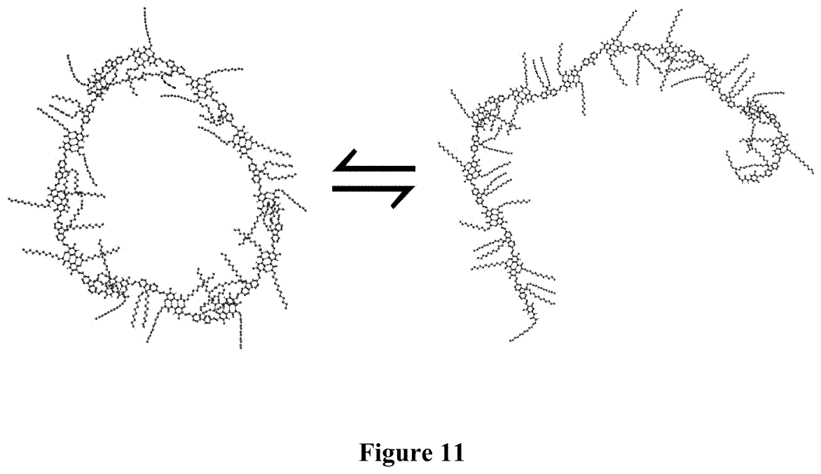

A supramolecular polymer exhibits ring-chain equilibrium and by extension, polymer conformation can be tuned by the amount of chain stoppers added, which in turn can be used to improve the sorting yield without compromising the purity or properties of sorted SWCNTs. A schematic of this is shown in FIG. 10. In a specific embodiment, a hydrogen-bonding polymer incorporating 2-ureido-4-pyrimidone (UPy) was used. The monomer consists of a fluorene moiety, which is known to be selective for semiconducting SWCNTs, flanked by two UPy units that enable reversible H-bonding. The stopper consists of a monofunctional UPy unit that can bind to the monomer, thereby preventing it from self-associating. The existence of ring-chain equilibrium in UPy-based systems is well-established, though the proportion of rings and chains can depend on various factors, such as monomer length, monomer rigidity, and π-π stacking. A schematic of the ring chain equilibrium described above is depicted in FIG. 11.

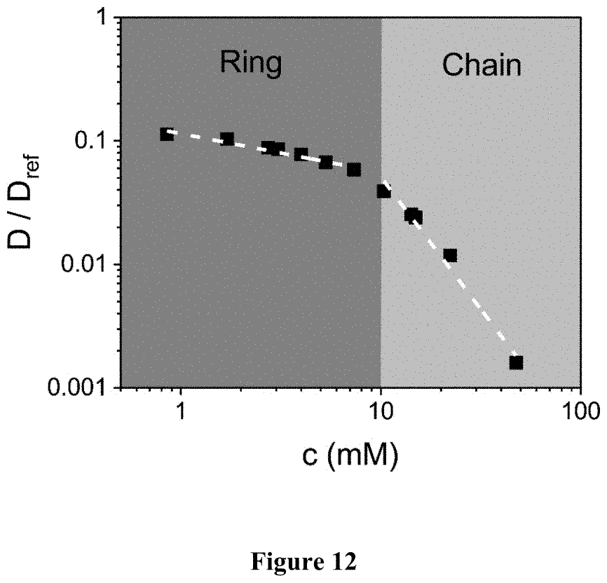

To determine the size of the supramolecular polymer in solution, a detailed study of diffusion-ordered NMR spectroscopy (DOSY) was initiated. This method is capable of measuring the diffusion coefficients of species in solution, which are inversely related to their hydrodynamic radii. DOSY was performed in CDCl₃, and the diffusion coefficient as a function of monomer concentration was extracted using the Stejskal-Tanner equation as described in Stejskal, E. O.; Tanner, J. E. Spin Diffusion Measurements: Spin Echoes in the Presence of a Time-Dependent Field Gradient. J. Chem. Phys. 1965, 42 (1), 288-292 (herein incorporated by reference in its entirety). The results are shown in FIG. 12. Two distinct regimes can be observed with a transition at c≅10 mM. This matches observations of ring-chain equilibrium in other supramolecular systems, where there is a critical monomer concentration below which a ring-like conformation is dominant, and above which rings and chains are both present.

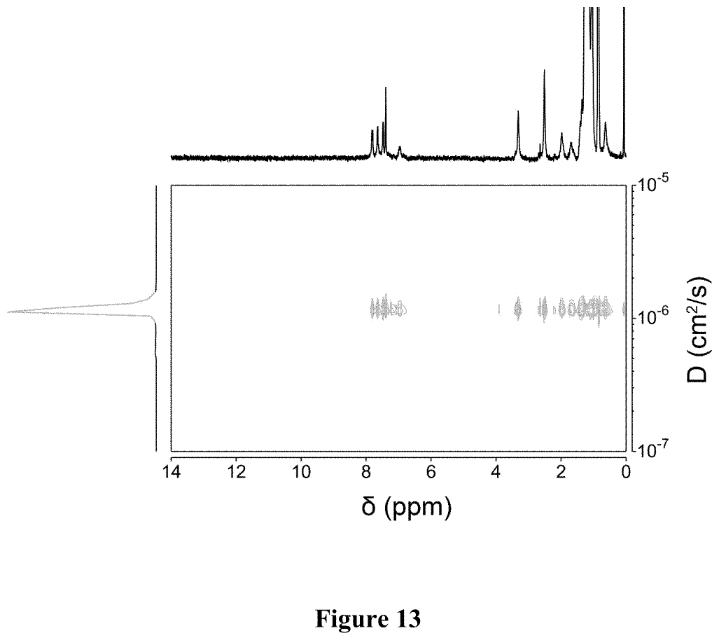

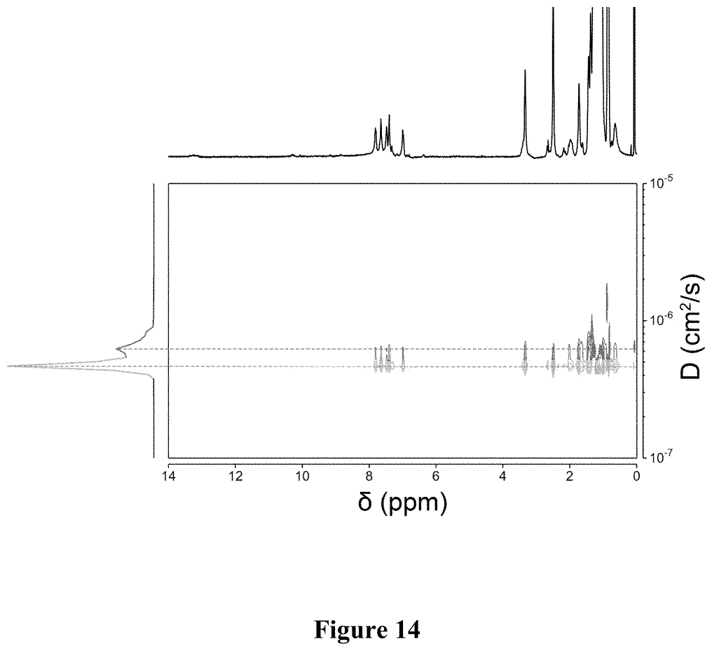

To further confirm the existence of ring-chain equilibrium in the system, a Bayesian DOSY transformation of the NMR data was performed as described by Cobas, C.; Seoane, F.; Sykora, S. Global Spectral Deconvolution (GSD) of 1D-NMR Spectra. Stans Libr. 2008, No. Volume II (herein incorporated by reference in its entirety). This is a technique that visualizes the distribution of diffusion coefficients in a multispecies system. For a sample with concentration c≅5 mM, only a single peak is visible as shown in FIG. 13 indicating that only one species is present. On the other hand, for a sample with c≅15 mM, a bimodal distribution is observed, suggesting the coexistence of two species of different sizes (FIG. 14). These results are in good agreement with the literature reports on ring-chain equilibrium, wherein chains can only exist at concentrations above the critical concentration.

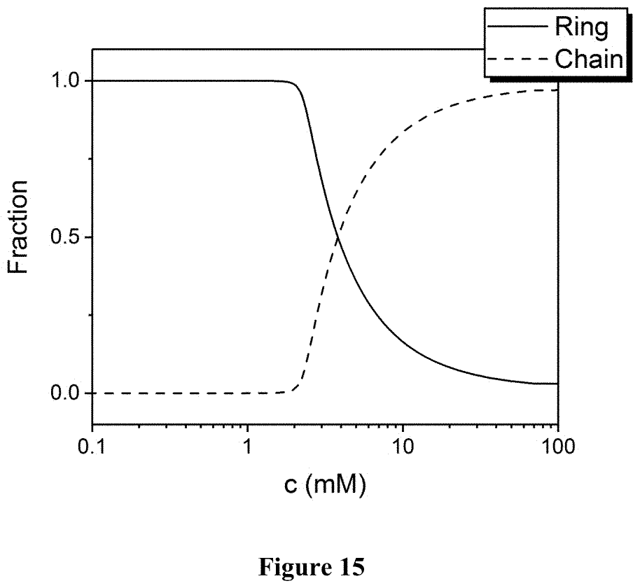

To further confirm the existence of ring-chain equilibrium in the system, a thermodynamic model described in Paffen, T. F. E.; Ercolani, G.; de Greef, T. F. A.; Meijer, E. W. Supramolecular Buffering by Ring-Chain Competition. Journal of the American Chemical Society 2015, 137, 1501-1509 (herein incorporated by reference in its entirety) was adapted and used to calculate the population of ring and chain species at different concentrations. The effective molarity (EM₁), a modeling parameter, was set to 1 mM, the value associated with strained, UPy-based rings. The model predicts that the fraction of rings and chains is equivalent at c≅2.5 mM (FIG. 15), which is in decent accordance with the experimental finding that the critical concentration in chloroform occurs at c≅10 mM (FIG. 12).

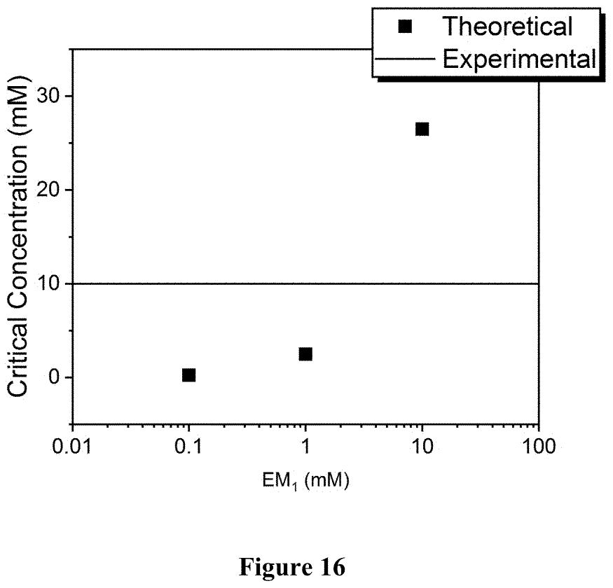

To ensure that EM₁=1 mM accurately describes this supramolecular polymer, the population of rings and chains was recalculated for a range of EM₁ values. The dependence of the critical concentration on EM₁ is illustrated in FIG. 16, showing order-of-magnitude for a wide range of EM₁ values.

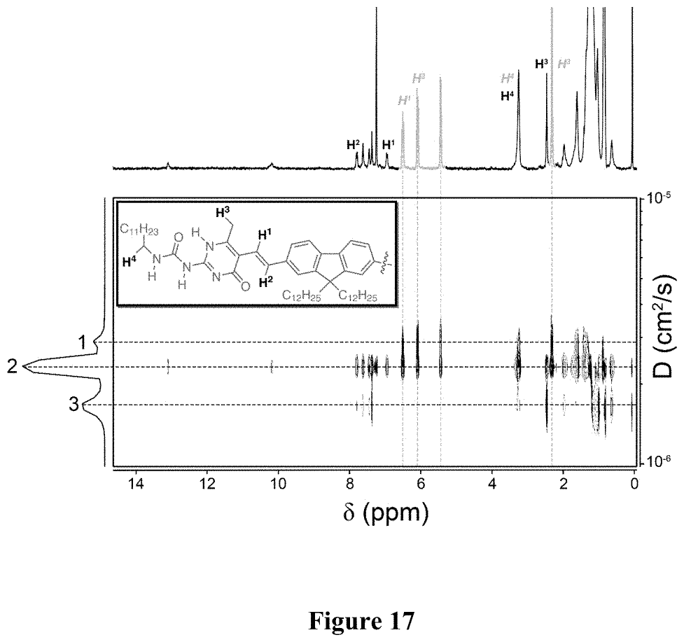

In yet another embodiment related to the subject invention, the polymer conformation was controlled using chain stoppers as described below. A high monomer concentration, c≅15 mM, was used to ensure that chains would be present in the sample. FIG. 14 shows a bimodal distribution along the diffusion axis, confirming the coexistence of rings and chains. FIG. 17 on the other hand reveals three distinct peaks along the diffusion axis, labeled as 1, 2, and 3 in order of highest to lowest diffusion coefficient. The species labelled as 1 and 2 exhibit ¹H resonances around 6 ppm, as well as a peak at 2.32 ppm, corresponding to an aryl methyl proton. Both of these resonances are characteristic of the stopper. This suggested that the species labelled as 3 does not contain the stopper molecule and can therefore be attributed to rings of the supramolecular polymer.

Contrarily, the species labelled as 1 and 2 must contain the stopper molecule. Species 1, however, does not contain any of the ¹H resonances associated with the monomer, indicating that species 1 represents stopper dimers formed by excess, unbound stopper molecules. This view is further supported by the fact that species 1 has the highest diffusion coefficient, while the species containing monomer (2 and 3) diffuse much slower. Since species 2 contains monomer as well as the stopper molecule, it most likely represents chains capped by stopper. These findings indicate that the stopper is indeed capable of capping polymer chains, and that the presence of stopper leads to the coexistence of rings, chains, and stopper dimers.

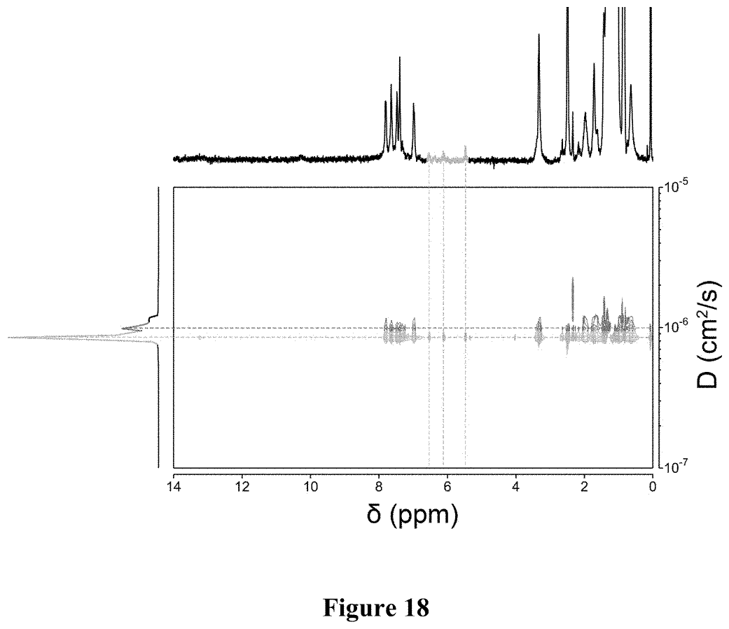

In order to determine the effect of stopper concentration or mole fraction on the size of the supramolecular polymer, DOSY was performed on a sample with a lower mole fraction of stopper (FIG. 18, xₛₜₒₚₚₑᵣ=0.17 instead of 0.72). Like in FIG. 17, ¹H resonances characteristic of the monomer and stopper can be observed for one of the species—in this case, the dark gray species—suggesting that the dark gray species are chains capped by stopper. The light gray species does not contain these resonances, and thus constitutes rings of the supramolecular polymer. Comparing these two samples shows that chains are the slowest diffusing species at xₛₜₒₚₚₑᵣ=0.17, while rings are the slowest diffusing species at xₛₜₒₚₚₑᵣ=0.72. As stopper is unlikely to affect the size of rings, this indicates that the addition of stopper also decreases the degree of polymerization of polymer chains, as expected for supramolecular systems.

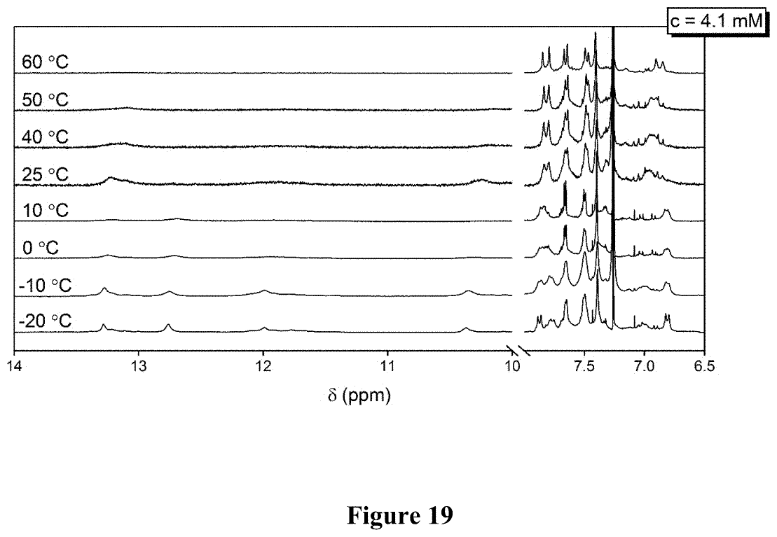

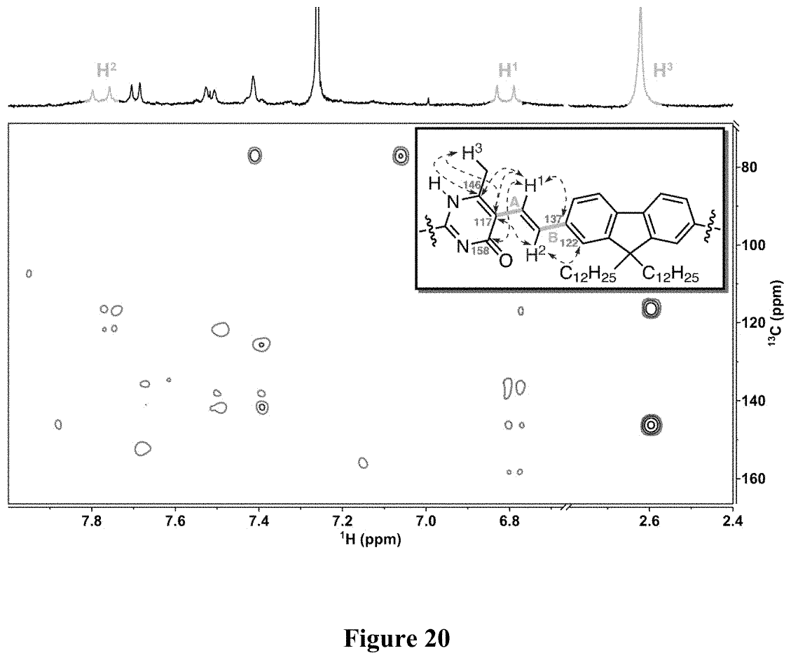

In order to determine the effect of process temperature on polymer conformation, variable-temperature (VT) NMR was performed. A low monomer concentration of c=4.1 mM was selected so that the dominant conformation would be rings at room temperature. For temperatures near room temperature, the peak of the olefin proton at 7.0 ppm is broad, but as temperature is increased or decreased, the peak sharpens (FIG. 19). The downfield H-bonding resonances around 12 and 13 ppm exhibit similar sharpening. Based on the DOSY results, this phenomenon can potentially be attributed to conformational exchange. Utilizing heteronuclear multiple bond correlation (HMBC) analysis, the ¹H resonance at 7.0 ppm was assigned to the atom labeled H¹ rather than H² (FIG. 20). This suggests that as temperature is changed, the rotation of bond A is either facilitated (increasing temperature) or frozen out (decreasing temperature). This in turn changes the timescale of conformational exchange during NMR spectra acquisition, ultimately resulting in the observed peak sharpening.

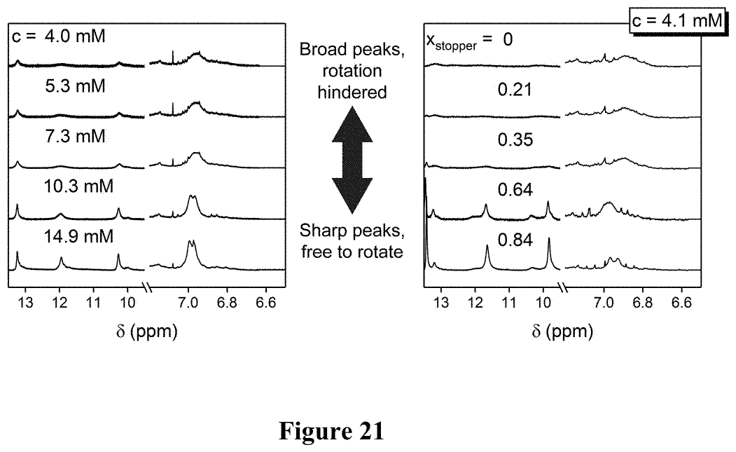

The possibility of conformational exchange is also supported by 1D ¹H NMR. Towards this end, NMR was used to analyze samples above and below the critical concentration without stopper (FIG. 21, left). When c is less than the critical concentration, the peak around 7.0 ppm is broad, but as c is increased, the peak sharpens, eventually forming a well-defined doublet. This implies that the conformation of the supramolecular polymer becomes less constrained as cis increased. This result qualitatively matches the concentration-dependent ring-chain equilibrium observed in DOSY Additionally, the peak begins to sharpen at around 10 mM, in quantitative agreement with the DOSY results.

A similar peak sharpening was seen when the stopper molecule was added to a sample with c lower than the critical concentration (FIG. 21, right). At low stopper mole fractions, or with no stopper present, there is severe broadening of the ¹H peak around 7.0 ppm, indicating that the polymer exists in a constrained conformation characteristic of rings. At high stopper mole fractions, the peak is sharp, suggesting that the polymer has a flexible conformation typical of chains. Furthermore, as chains normally do not exist in dilute conditions, this demonstrates that the stopper is capable of disrupting rings of the supramolecular polymer even at monomer concentrations below the critical concentration. Altogether, these NMR results show that the conformation distribution can be skewed towards chains by increasing temperature or by adding chain stoppers.

Hitherto, the characterization of the supramolecular polymer has been performed in chloroform due to its poor solubility in other common organic solvents. SWCNT sorting, however, is typically done in aromatic solvents like toluene, rather than polar solvents like chloroform. This is often hypothesized to arise from screening of the dipole interactions of metallic SWCNTs by polar solvents, preventing aggregation of metallic SWCNTs during centrifugation. As the solubility of the monomer in toluene was too low (<1 mM) for in-depth NMR or rheology studies, solution SAXS was used to study the size of the supramolecular polymer as a function of stopper mole fraction.

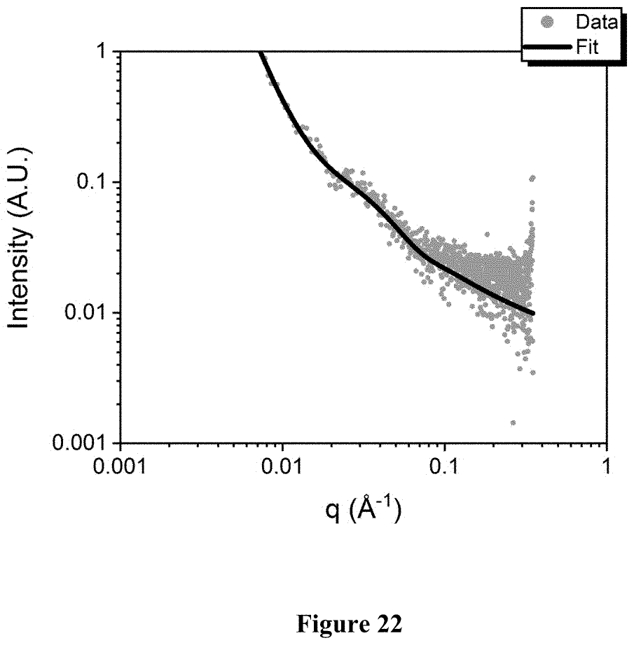

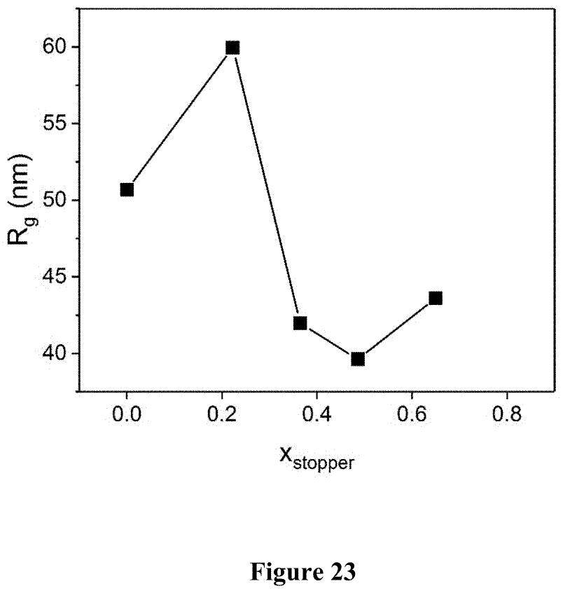

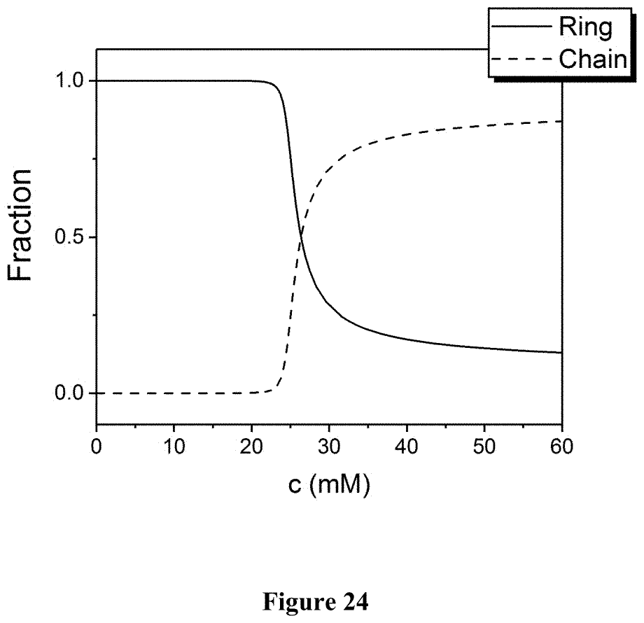

The SAXS spectra were fitted using a two-level unified fit in Igor Pro (FIG. 22). FIG. 23 reveals that the average radius of gyration initially increases and then decreases as stopper is added. The initial increase in R_{g} can be attributed to increased aggregation—as stopper is added, rings unfold into chains, which can aggregate more easily compared to rings. The decrease in R_{g} is likely due to shrinking of chains. These results indicate ring-chain equilibrium also takes place in toluene. This conclusion is further supported by thermodynamic modeling, which predicts ring-chain equilibrium with a critical concentration around 26 mM (FIG. 24). This suggests that for toluene, rings are the dominant conformation at all experimentally accessible concentrations.

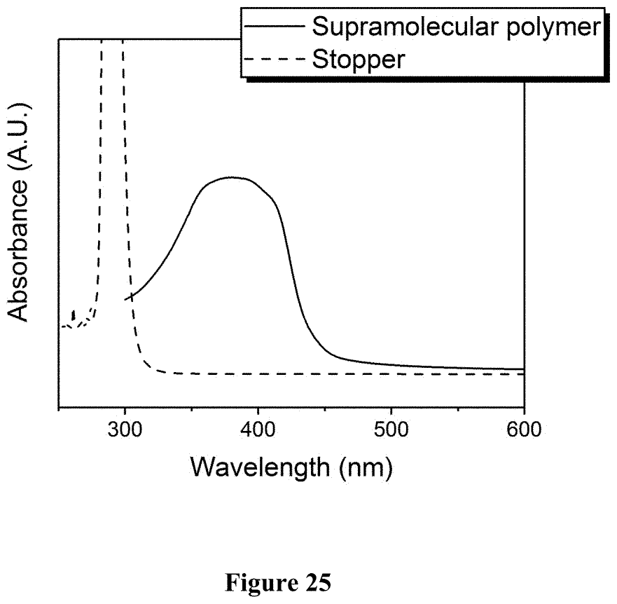

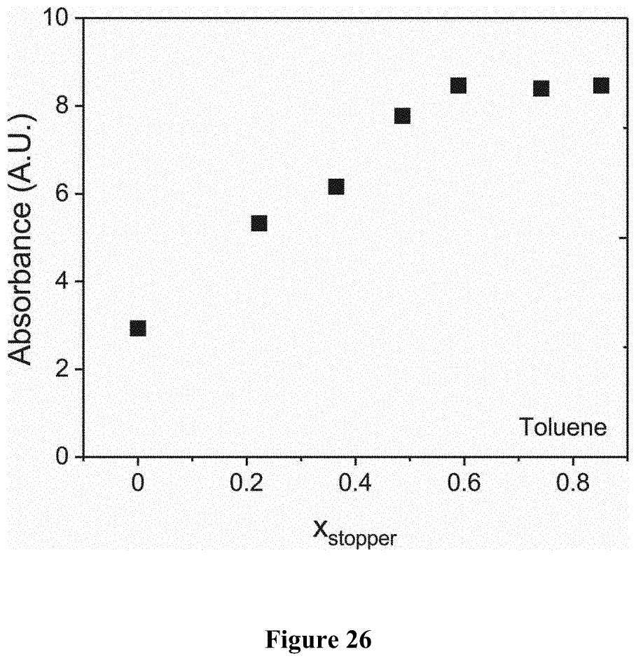

In addition to solution SAXS, the hyperchromic effect, which describes changes in absorbance as a function of bond dissociation, was also used to study this system. This effect is particularly well-known for DNA and has been observed in other supramolecular systems. To ensure that this analysis is valid, UV-vis was performed to verify that the stopper and polymer do not have overlapping UV-vis peaks (FIG. 25). As shown in FIG. 26, the absorbance of the supramolecular polymer increases linearly with stopper mole fraction up to a certain point where it plateaus. Intuitively, this suggests that as stopper is added, the polymer strands dissociate and shorten until the solution is composed solely of trimers—a supramolecular monomer bonded to two chain stoppers. In theory, when xₛₜₒₚₚₑᵣ is 0.66, there is exactly two stopper molecules for each monomer, which is in good agreement with the presented data, as the plateau begins at xₛₜₒₚₚₑᵣ≅0.6.

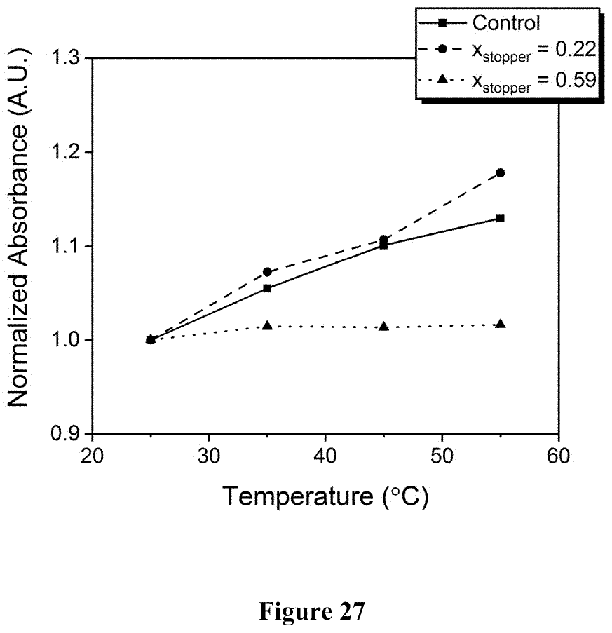

To confirm that the polymer is fully depolymerized at high stopper mole fractions, the temperature-dependent hyperchromicity was measured for samples with varying stopper mole fractions (FIG. 27). At a high stopper mole fraction, no change in absorbance is observed as the temperature is changed, implying that the polymer exists in a trimeric form and cannot depolymerize further. Conversely, at low stopper mole fractions or with no stopper present, absorbance increases with temperature. This result demonstrates that stopper can disrupt supramolecular polymerization in both solvents, despite an order of magnitude difference in the dimerization constant.

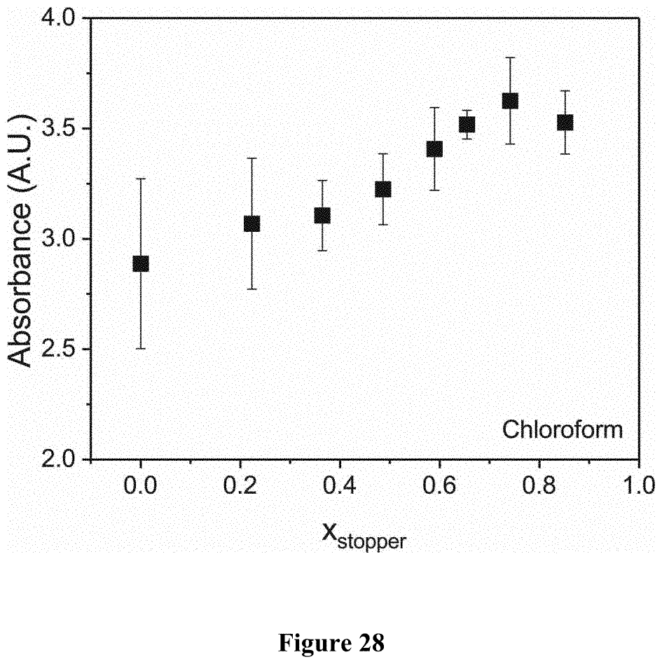

The hyperchromic effect in chloroform was also examined in a related embodiment. Like FIG. 26, FIG. 28 shows that absorbance increases with xₛₜₒₚₚₑᵣ up to 0.66, and plateaus afterwards. This result suggests that the polymer-stopper interaction is similar in both solvents, and that the insight gained from characterizing the supramolecular polymer in chloroform may be applicable to understanding SWCNT sorting in toluene.

SWCNT sorting was performed by following established procedures. In brief, stopper and monomer (c=0.2 mM) were dissolved in 20 mL of solvent, then mixed with 5 mg of unsorted arc-discharge SWCNTs and ultrasonicated. A slightly different stopper—with an iodide moiety rather than a vinyl group—was used for these set of experiments due to synthetic accessibility. The sorted SWCNT solution was collected after centrifugation, and subsequently analyzed by UV-vis to determine yield and purity. Purity is defined by metric φ, where a φ of 0.4 corresponds to a purity of 99%.

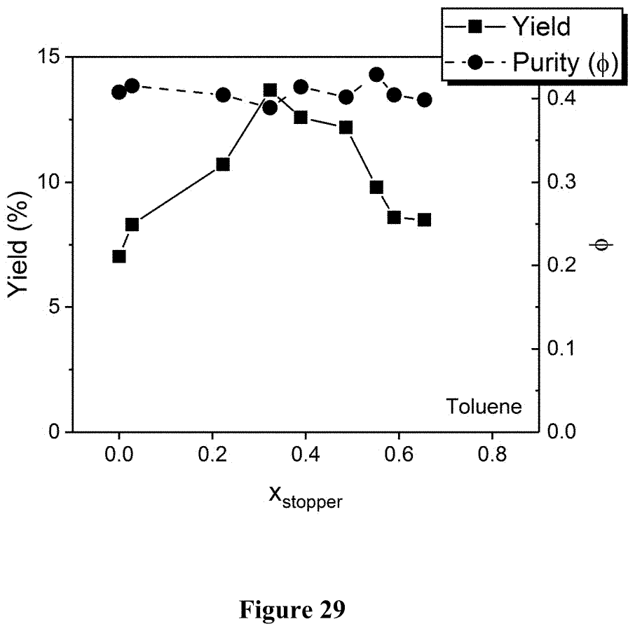

FIG. 29 shows that there is no significant change in purity as the stopper mole fraction is increased, whereas yield first increases, then decreases. The NMR, SAXS, and UV-vis results reported above suggest that the addition of stopper causes the rings to unfold, followed by shortening of chains. The initial increase in yield can therefore be attributed to the formation of chains, as chains can effectively wrap around SWCNTs, while rings cannot. The ensuing decrease in yield is likely due to reduction of chain length, as very short chains are known to diminish yield. At xₛₜₒₚₚₑᵣ≅0.6 there is no further change in sorting yield as a function of stopper mole fraction, which matches the point in FIG. 26 where no further hyperchromicity can be observed. It can be postulated that the polymer has been completely reduced to trimers at this value of xₛₜₒₚₚₑᵣ, and as stopper dimers are unable to sort SWCNTs on their own, further addition of stopper beyond xₛₜₒₚₚₑᵣ=0.66 has no effect on SWCNT sorting efficacy.

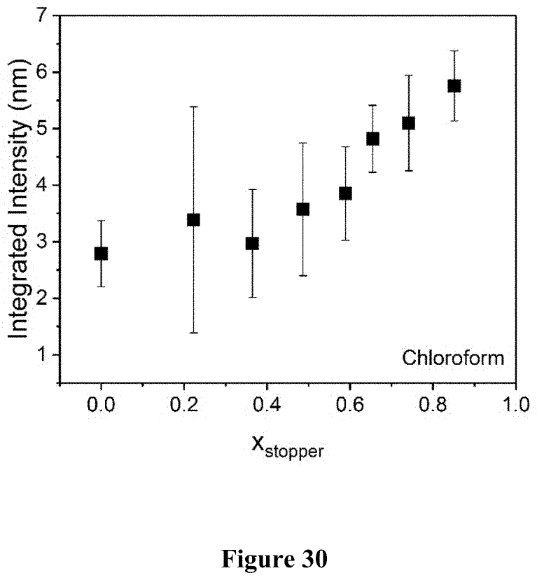

To corroborate this conclusion, SWCNT sorting in chloroform was also performed (FIG. 30). Though sorting in chloroform does not allow for selective purification of SWCNTs by electronic type, the dispersion yield—measured by integrating the SWCNT UV-vis absorption peaks—can be used to gauge the polymer's ability to disperse SWCNTs. It was found that low stopper mole fractions (xₛₜₒₚₚₑᵣ<0.4) have no effect on the integrated intensity, but at higher mole fractions, integrated intensity increases with xₛₜₒₚₚₑᵣ. Unlike the results in toluene, no decrease is seen at high values of xₛₜₒₚₚₑᵣ.

The monotonic increase in yield can be attributed to differences in the solubility of SWCNTs in each solvent. From a thermodynamic perspective, the free energy of solvation can be described as:

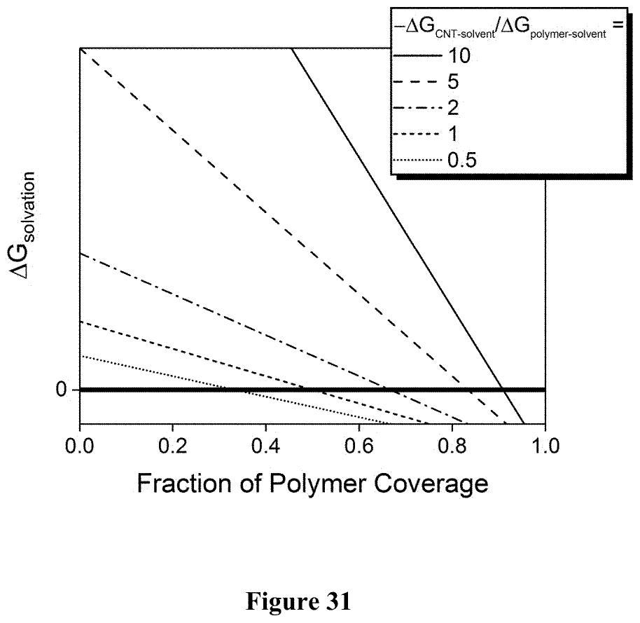

ΔGₛₒₗᵥₐₜᵢₒₙ=ΔG_{polymer-solvent}*f+ΔG_{CNT-solvent}*(1−f)

Where f is the fraction of the SWCNT surface wrapped by polymer. FIG. 31 depicts the free energy of solvation for solvents with different ratios of SWCNT/polymer solubility. If SWCNT solubility is poor—as is the case for toluene—a high value of f is needed for solvation to occur. Chloroform, in contrast, has moderate SWCNT solubility, so the requirements for polymer wrapping are less stringent, i.e., SWCNT solvation can occur at lower values off.

It is expected that as stopper is added, the total number of polymeric chains in solution increases, while the average degree of polymerization decreases. SWCNTs are consequently solubilized by several small oligomers rather than being wrapped by a single long polymer, leading to a lower f-value. For toluene, this causes a decrease in yield at high values of xₛₜₒₚₚₑᵣ. For chloroform, however, lower f-values can still result in solvation, thus, yield increases monotonically with the total number of chains in solution, which scales with xₛₜₒₚₚₑᵣ,

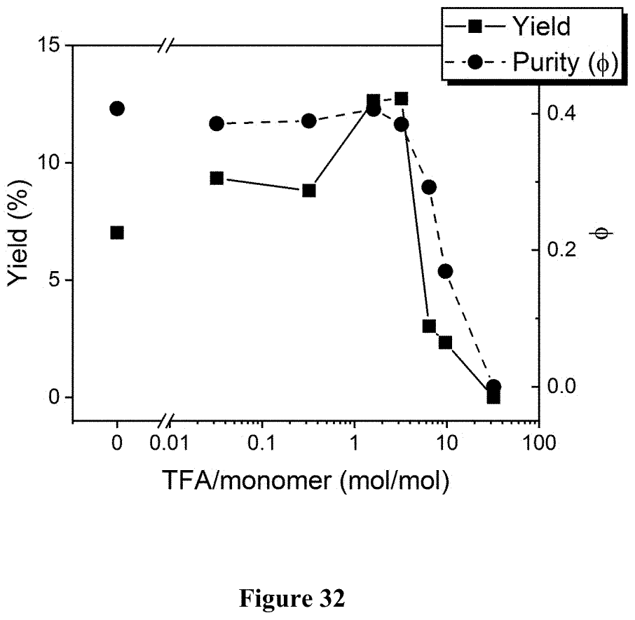

The experimental results presented above show that SWCNT sorting efficacy can be enhanced by engineering the conformation and molecular weight distribution of the sorting polymer. Moreover, these results are not unique to the choice of chain stopper, as in yet another embodiment, even adding small amounts of trifluoroacetic acid (TFA)—a molecule typically used to depolymerize the supramolecular polymer—yielded similar behavior (FIG. 32).

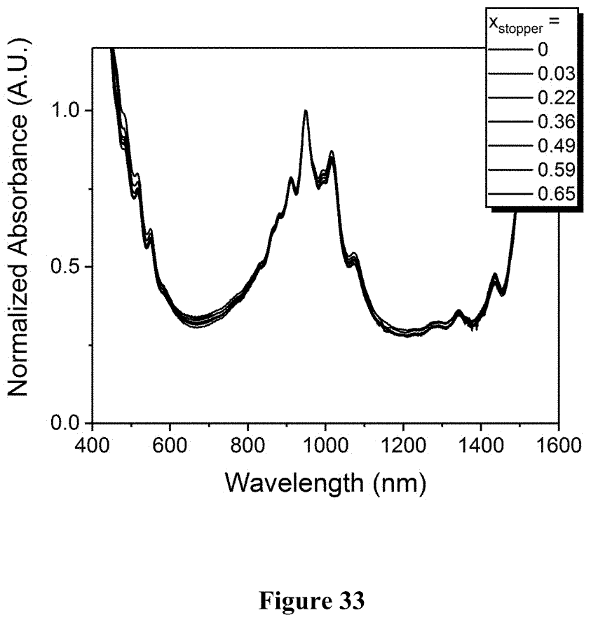

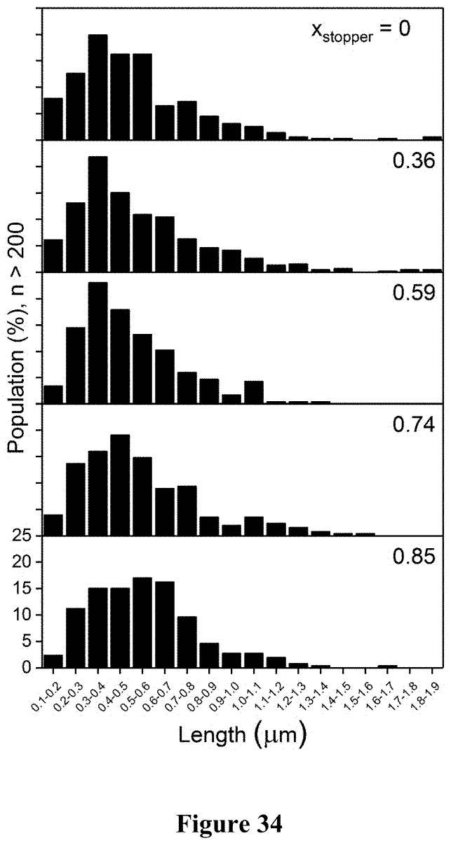

In yet another embodiment, SWCNTs were sorted with different stopper mole fractions to determine whether polymer conformation has any effect on SWCNT properties. FIG. 33 depicts the UV-vis spectra of SWCNTs sorted at various stopper mole fractions. All the spectra overlapped quite well, indicating no change in chiral distribution. FIG. 34 shows AFM length histograms of sorted SWCNTs, with no significant differences between them.

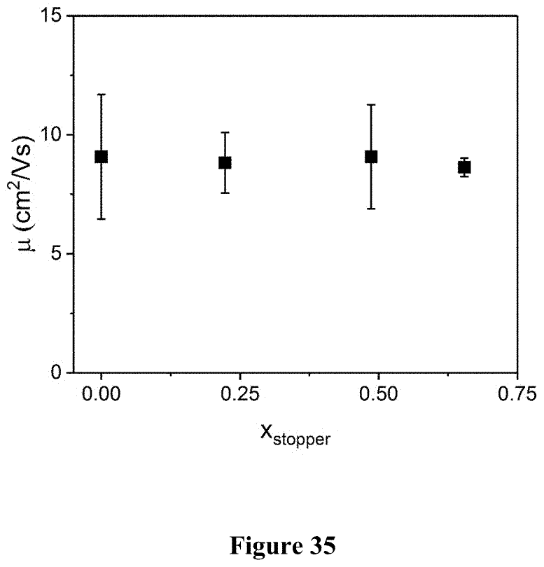

To test the electrical properties of the sorted SWCNTs, field-effect transistors with said SWCNTs as the channel material were fabricated. FIG. 35 shows the field-effect mobility, which does not change with the stopper mole fraction. The presented results demonstrate that stopper can be used to enhance sorting yield without adversely affecting the properties of sorted SWCNTs.

1. A method for separating single-walled carbon nanotubes (SWNTs) from a mixture comprising SWNTs of a plurality of electronic types, chiralities or subset thereof comprising,
a) providing a separation mixture comprising a supramolecular polymer and/or chemical additive, and a solvent,
wherein the supramolecular polymer is configured to selectively disperse SWNTs of one electronic quality, chiral portion, or subset thereof from the SWNT mixture, and
wherein the chemical additive increases at least one of:
i) selectivity of the supramolecular polymer, or
ii) ability of the supramolecular polymer to enhance the separation yield of SWNTs of the one electronic quality, chiral portion, or subset thereof; and
b) isolating a composition enriched in SWNTs of an electronic quality, chiral portion, or subset thereof.

2. The method of claim 1, wherein the supramolecular polymer comprises a disassembled supramolecular polymer, and the providing step further comprises providing a bond disrupting agent and adding an antisolvent to the solution.

3. The method of claim 1, further comprising precipitating the supramolecular polymer and isolating the precipitated supramolecular polymer.

4. The method of claim 1, wherein the separation mixture comprises a dispersed complex comprising the supramolecular polymer and SWNTs of one electronic quality, chiral portion, or subset thereof.

5. The method of claim 4, further comprising providing a bond disrupting agent to the dispersed complex.

6. The method of claim 5, wherein the supramolecular polymer is disassembled and SWNTs of one electronic quality, chiral portion, or subset thereof are released.

7. The method of claim 1, wherein the chemical additive comprises a structural unit that interacts with SWNTs.

8. The method of any of claim 1, wherein the chemical additive comprises a structural unit selected from the group consisting of: 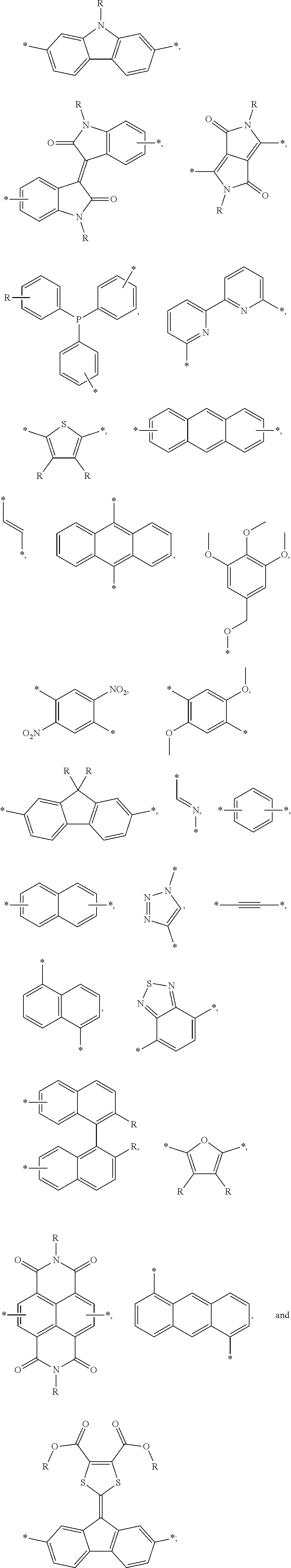
wherein
each R group is independently selected from the group consisting of H, F, Br, Cl, —CN, —NC, —NCO, —NCS, —OCN, —SCN, —C(O)NR⁰R⁰⁰, —C(O)X⁰, —C(O)R⁰, —C(O)OR⁰, —NH₂, —NR⁰R⁰⁰, —SH, —SR⁰, —SO₃H, —SO₂R⁰, —OH, —NO₂, —CF₃, —SF₅, or optionally substituted silyl, carbyl or hydrocarbyl with 1 to 40 C atoms that is optionally substituted and optionally comprises one or more hetero atoms;
each R⁰ and R⁰⁰ are independently H or optionally substituted C₁₋₄₀ carbyl or hydrocarbyl; and
X⁰ is halogen.

9. The method of claim 8, wherein R⁰ and R⁰⁰ are independently H or alkyl with 1 to 12 C-atoms.

10. The method of claim 8, wherein X⁰ is F, Cl or Br.

11. The method of claim 1, wherein the chemical additive comprises one or more groups capable of chelation, hydrogen bonding, pi-stacking, ionic interactions, dipole interactions, Van der Waals interactions, or any combination thereof.

12. The method of any of claim 1, wherein the chemical additive interacts with the supramolecular polymer.

13. The method of any of claim 1, wherein the chemical additive comprises a structural unit selected from the group consisting of: 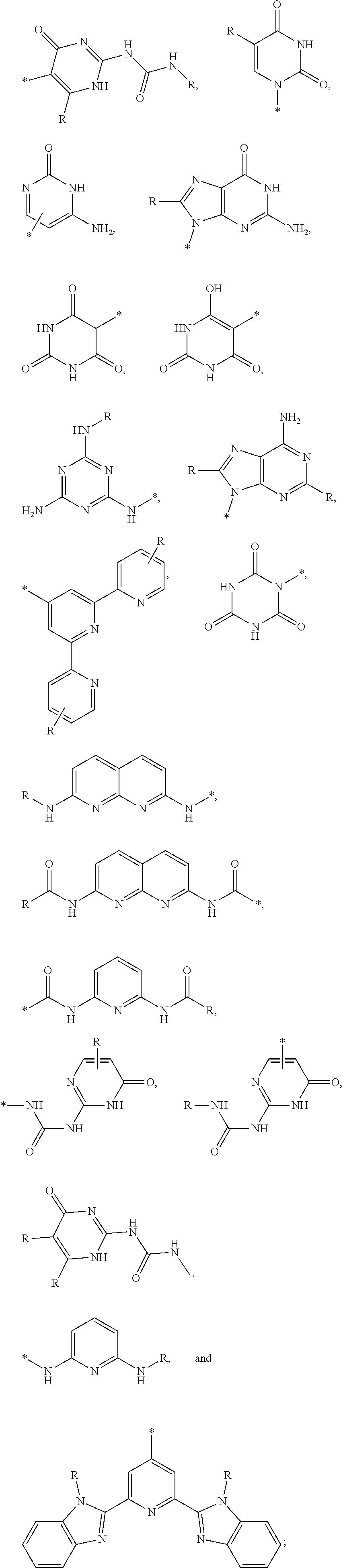
wherein
each R group is independently selected from the group consisting of H, F, Br, Cl, —CN, —NC, —NCO, —NCS, —OCN, —SCN, —C(O)NR⁰R⁰⁰, —C(O)X⁰, —C(O)R⁰, —C(O)OR⁰, —NH₂, —NR⁰R⁰⁰, —SH, —SR⁰, —SO₃H, —SO₂R⁰, —OH, —NO₂, —CF₃, —SF₅, or optionally substituted silyl, carbyl or hydrocarbyl with 1 to 40 C atoms that is optionally substituted and optionally comprises one or more hetero atoms;
each R⁰ and R⁰⁰ are independently H or optionally substituted C₁₋₄₀ carbyl or hydrocarbyl; and
X⁰ is halogen.

14. The method of claim 13, wherein R⁰ and R⁰⁰ are independently H or alkyl with 1 to 12 C-atoms.

15. The method of claim 13, wherein X⁰ is F, Cl or Br.

16. The method of claim 1, wherein the chemical additive modifies solubility.

17. The method of any of claim 1, wherein the chemical additive comprises a structural unit selected from the group consisting of:

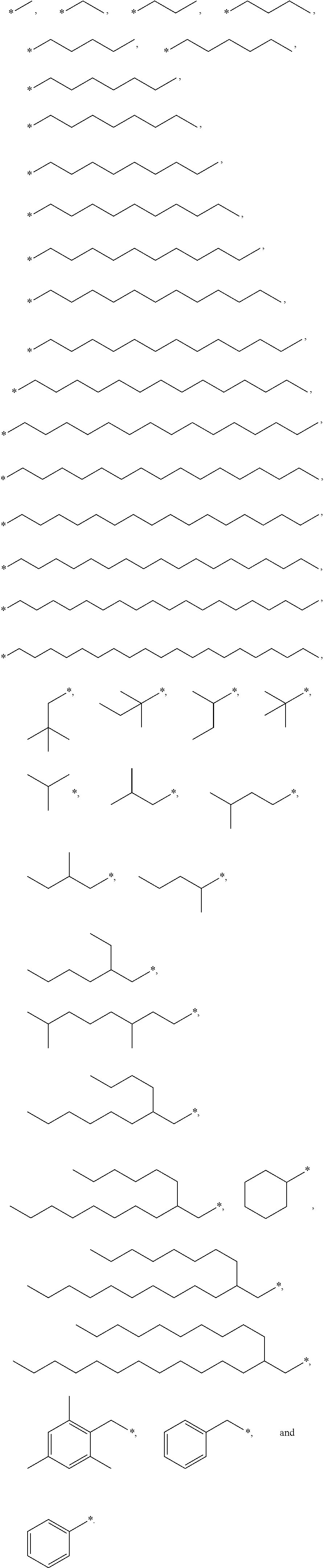

18. The method of any of claim 1, wherein the chemical additive is selected from the group consisting of:

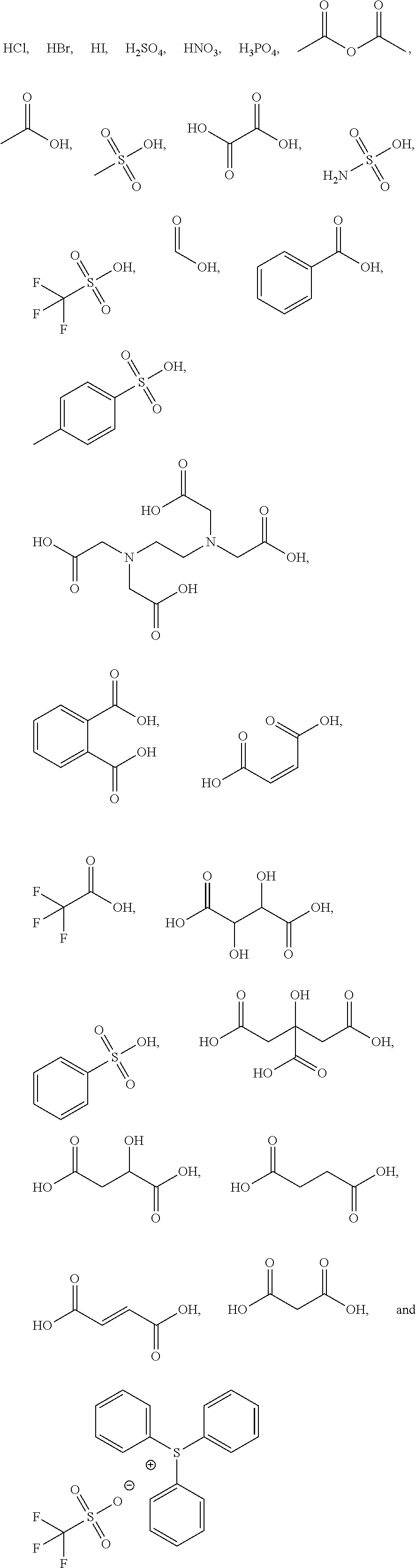

19. The method of any of claim 1, wherein the chemical additive comprises an inorganic complex.

20. The method of any of claim 1, wherein the chemical additive comprises an organo-metallic complex.

21. The method of claim 1, wherein the separation mixture of claim 1 does not comprise a supramolecular polymer.

22. The method of claim 1, wherein the performance of the supramolecular polymer is optimized and calibrated reproducibly by measured addition of the chemical additive.
